(19) United States
(12) Patent Application Publication
(10) Pub. No.: US 2008/0085497 A1
(43) Pub. Date: Apr. 10, 2008

(54) Method for enhancing leadership, entrepreneurship, performance, innovation, creativity, and career achievement.

(76) Inventor: Lauren L. Holmes, Toronto (CA)

Correspondence Address: LAUREN L. HOLMES, 123 QUEEN STREET WEST, BOX 164, TORONTO, ON, M5H-3M9, US

(21) Appl. No.: 11/532,754

(22) Filed: Sep. 18, 2006

(51) Int. Cl. G09B 19/00

(52) U.S. Cl. 434/236

(57) ABSTRACT

A method for cultivating a dynamic foundation of leader drives, reflexes, and meta-competencies through a paradigm shift to a paradigm composed of a logically integrated system of dynamics. These dynamics pertain to how systems synergistically adapt, advance and co-evolve to attain and sustain peak performance. The paradigm shift is achieved through a series of presentations, quantum leaps, belief upgrades, exercises, and action-learning experimentation which provide component systems of beliefs and information until the full paradigm has been assimilated. The invention launches a series of self-motivating growth continuums which capitalize on natural mechanisms and drives to trigger life-long development. The dynamic foundation improves the assimilation and use of classic leader competencies taught by traditional leadership development and performance improvement programs to create more impactful leaders, entrepreneurs, innovators, and individuals.

### CROSS REFERENCE TO RELATED APPLICATIONS

Not Applicable

### FEDERALLY SPONSORED RESEARCH

not applicable

### SEQUENCE LISTING OR PROGRAM

not applicable

### FIELD OF THE INVENTION

The present invention relates to the fields of leader creation, leadership development, professional development, career development, adult personal development, abstract and conceptual development, leadership, entrepreneurship, peak performance, organizational productivity, change management, and education. This invention addresses (a) the global leadership shortage; (b) the conceptual skills shortage emerging with our conceptual-based economy (c) the need for improved employee productivity; (d) the blended needs arising from the talent wars and the trend towards career self-management for a career process which co-evolves the company and the individual to the advantage of both; and (e) the need for a more effective change management process.

### BACKGROUND OF THE INVENTION

The present invention has been developed in response to the present state of the art, and in particular, in response to the problems and needs in the art that have not yet been fully solved by currently available methods for professional, leadership, organizational, and career development. Accordingly, the present invention has been developed to provide a method for development that overcomes many or all of the below-discussed shortcomings in the art. Because the objects of the invention are extensive they have been provided in a separate section following the Brief Summary.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The elements of relevant prior art have been listed individually and numbered so that the invention differences, numbered to match the prior art items, can be addressed individually and specifically. This process should enable greater clarity as to how the present invention both fits in and is differentiated.

### COMPARISON TO PRIOR ART

Prior Art 1: Leader Competencies and Skills are Taught:

Traditional leadership development programs tend to focus on teaching leader competencies and skills such as technical skills, communication skills, and cognitive skills.

Invention Difference 1: A Dynamic Leader Foundation is Installed:

This invention installs within individuals a logically integrated dynamic leader infrastructure into which classic leader competencies can be more effectively and cohesively embedded. This dynamic foundation provides the leader drives, reflexes, instincts, impulses, dynamics, meta-competencies, identities, modus operandi, and consciousness of natural leaders as an integrated system or paradigm.

Prior Art 2: Piecemeal Leadership Development Teaching Unlinked Skills:

Traditional leadership development programs tend to teach standalone leader skills rather than a model or a system. Standalone leadership skills means a student has (a) more techniques to learn (b) more integration to be done to assimilate and use them (c) more challenge to integrate the skills into his or her existing work context. Consequently, current leadership development programs may not have a lasting impact.

Invention Difference 2: Holistic Leadership Development Installing an Integrated System of Meta-Competencies:

This invention installs a single systems management process to be applied to every human system, the participant's own system or any system led. Only a few basic skills are therefore required to lead or advance any human systems in the paradigm of this invention. These skills are all logically integrated into a paradigm and can therefore be logically deduced from each other.

Prior Art 3: Standalone Leader Competencies Taught:

Most leadership development programs seek to develop leader skills or competencies.

Invention Difference 3: A System of Leader Meta-Competencies Installed by a Paradigm Shift

The present invention cultivates leader meta-competencies. It teaches no leader competencies and skills directly. Meta-competencies are systems of knowledge, skills, and strategies which make the acquisition of new competencies and the use of available competencies more adaptive and efficient. They are enablers for the use of classic leadership competencies traditionally taught in leadership development programs.

Leader meta-competencies emerge as a byproduct of the paradigm shift to a paradigm consisting of leader dynamics, quantum leaps, a paradigm-based quantum leap method, and new modi operandi. The meta-competencies form a dynamic foundation upon which leader competencies can then be embedded. Examples of categories of leader meta-competencies resulting from the present invention include those relating to learning, knowing, creating, frontiering, cognitive capabilities, accelerated growth, evolution, peak performance, talent-based flow, systems thinking, system-based emotional intelligence, expanding consciousness, expanding self-awareness and internal reference, expanding self-expression, continuous adaptation and re-optimization and agility, co-evolution with contextual systems, fluidity, informationless decision-making, achievement and advancement by nonlinear quantum leap, and accelerated implementation.

The following are six references promoting the importance of meta-competencies over competencies for leadership development:

(a) The US Army's Training and Leader Development Panel (ATLDP) have found that it is more important to install meta-competencies than competencies. The 2002 Officer Study concluded that, because of the ambiguous nature of the future operating environment, leaders should focus on developing enduring competencies known as meta-competencies. These meta-competencies are the essential building blocks of learning. Although specific descriptions of such meta-competencies differ, there is a consensus that competences alone are insufficient and must be supported by higher order qualities.

(b) R. B. Brown (1994: 289-299) similarly argues in favor of the over-arching or underpinning meta-competencies: “the higher-order abilities, which have to do with being able to learn, adapt, anticipate and create, rather than with being able to demonstrate that one has the ability to do.” (R. B. Brown, 1993: 32).

(c) For D. T. Hall (1986) the most important meta-skill is skill in acquiring other skills,

(a) For Snell (1990) these meta-qualities include creativity, mental agility and balanced learning skill.

(d) Cheetham and Chivers (1996: 24) include communication, self-development, creativity, analysis and problem solving in their definition of meta-competencies.

(e) The common theme with meta-competencies is that they address the cognitive aspects of management, concerning the ability to cope with uncertainty, as well as learning and reflection (Nordhaug, 1993). Learning to learn is perhaps the most fundamental meta-competency for developing entrepreneurship and leadership since the rapidity of technological developments and the dynamism of markets renders the traditional sources of competitive advantage liable to obsolescence and being superseded by innovation. The meta-competency that leaders need to cope with and implement change in the future is therefore learning. Sustainable competitive advantage derives from the ability of individuals and organizations to adapt and learn faster than the competition.

Prior Art 4: Bottom-Up Building of Leaders Skill by Skill

Traditional leadership development programs tend to address the development of leader competencies not leader meta-competencies. They tend to build those competencies one by one. Leaders are built from the parts to the whole. Only a small percentage of programs integrate those competencies back into a practical framework that can be applied in the work context. Of those programs providing a framework or model, only a small percentage address the total leader and leadership role. Most address a portion of the leader and/or leadership role. They fragment the leader and the leadership role into addressable parts.

Invention Difference 4: Top-Down Release of Leadership as an Extension of an Integrated System of Dynamics Found in All Individual and Organizational Human Systems.

Rather than building up the leader meta-competencies one by one as the leadership development programs tend to do with the competencies, the invention operates in reverse: from the whole, and only when necessary, to the parts. The invention operates from the perspective of unified consciousness or the interconnectedness and co-evolution of all human systems and works backwards to the system of the individual along continuums of shared themes and modi operandi. Leadership is redefined as a natural expression of the set of dynamics evident in all human systems. The leader meta-competencies are integrated into the paradigm of this invention as dynamics and emerge synergistically as an integrated system with the paradigm shift and action-learning experimentation support of the present invention. The meta-competencies motivate, energize, and enable the classic leader competencies taught by traditional leadership development programs.

Prior Art 5: A Focus on the Assimilation of Information:

Traditional programs operate as if leadership development is a linear progression based on the intellectual assimilation of information about how to lead. Most traditional leadership development programs comply with a strategy based on the hope that by learning the tools of leadership, a leader will emerge. The progression of leadership skills taught parallels the linear progression up a hierarchical organization to leadership roles with greater complexity, impact, and span of influence.

Invention Difference 5: A Focus on the Assimilation of Dynamics:

Unlike traditional leadership development, the present invention does not assume that the difference between a leader and non-leader is information or skill. It assumes the difference is dynamics. In the present invention, leaders are created and empowered by activating the dynamic foundation of integrated reflexes, instincts, impulses, identities, meta-competencies, and consciousness which are evident in all human systems and are the links for the species to nature's systems management process or process of system co-adaptation, co-evolution, and synergy.

Both nature and natural leaders manage systems identically for survival, adaptation to environmental changes, advancement, co-evolution synergy, and peak performance. Therefore, the invention metaphorically mirrors and capitalizes on natural adaptive processes internal and external to systems whether those systems are individual people, teams, organizations, companies, customers, suppliers, markets, or projects, processes, disciplines, and careers. Natural leaders are integrated into nature's systems management process. Some never left that integration into which all children are born. Others find that integration again later in life, often after traumatic events which re-center them onto their natural core as the present invention does.

The invention enables leadership, entrepreneurship, and leadership, personal, organizational, and career development to use the same holistic, systems-based, nonlinear processes and mechanisms found in nature. Since, in the metaphoric view of nature presented, nature is already fully integrated, the process of this invention is also fully integrated.

The direction of leadership development in the present invention is nonlinear. Expanding or intensifying the individual around his/her natural core while increasing the baseline functionality of the individual is the means for the invention to increase leader impact and span of influence.

Prior Art 6: The Application of Systems Thinking to Leadership:

Peter Senge, author of bestseller “The Fifth Discipline” and senior lecturer at the Massachusetts Institute of Technology writes in this book, “I call systems thinking the fifth discipline because it is the conceptual cornerstone that underlies all of the five learning disciplines of this book.”

While intellectually persuasive, the application of systems theory and science to leadership has not translated successfully to practical implementation: “ . . . that movement hit a few speed bumps. People who adopted the themes and practices of “The Fifth Discipline” sometimes found themselves frustrated by the challenge of bringing about effective change—and sometimes found themselves out of work for trying.” (Fast Company May 1999: 178)

Consequently, programs thus based are no longer popular and available despite the fascination with Peter Senge's approach in “The Fifth Discipline”. Systems theory has rarely been applied to leadership or personal development as it is in this invention.

Invention Difference 6: The Transparent Application of Systems Thinking Identically to Both Leading and Leadership Development and the Advancement of All Human Systems:

Whether for leading or for leadership development, the paradigm of this invention extends and capitalizes on nature's systems management process. The invention is 100% systems-based. However, the application of systems theory and other sciences (quantum physics, chaos theory, catastrophe theory, the biological sciences, systems theory, emergence theory, evolutionary theory, etc.) are all transparent to the user. They are neither taught nor applied directly. The invention has incorporated them into a paradigm based on science and how nature operates without referencing them. Participants need only learn the paradigm of this invention to be able to apply all of the science behind it. The invention targets application and implementation not theory. The science has been translated into a new modus operandi incorporated into the paradigm of this invention.

With the failure of the practical application of his “Fifth Discipline” systems thinking, Peter Senge, a renowned expert in organizational change and leadership, began to promote an integration into nature consistent with the strategy behind the present invention: “The most universal challenge that we face is the transition from seeing our human institutions as machines to seeing them as embodiments of nature . . . . We need to realize that we're a part of nature, rather than separate from nature.” This invention is the practical application of Senge's philosophy extended to leading, leadership development, and the orchestration of all human systems.

Prior Art 7: A ‘Manual’ Approach to Leadership Development:

Traditional leadership develop programs offer a manual approach which is limited by (a) the knowledge, intelligence, learning, and functionality of both the teacher and the student; (b) the discipline of the student in applying what has been taught; (c) the quality of the information provided; (d) the quality of the learning (e) the ability to apply the models and information to the work context.

Invention Difference 7: ‘Automatic’ Nature-Driven Leadership Development:

Natural mechanisms built into human systems for growth, learning, adaptation and evolution are harnessed by the present invention for the advancement of a participant's own system or systems led. The invention initiates an intrinsically rewarding, nature-driven leadership development, performance improvement, and evolutionary process.

Leadership development is induced by natural stimuli and events in reality which trigger natural mechanisms. Conditioned reflexes installed by the invention invoke specific behavioral responses to patterns of natural drives internally and patterns of events externally. The invention taps into the natural way in which the person as a system is designed to evolve so that his/her natural drives are pulling him/her forward to stronger leader meta-competencies.

The present invention offers ‘automatic’ nature-driven leadership development which is enhanced by
(a) nature's superior intelligence, information, creativity, and power, and existing mechanisms and forces
(b) nature's systems management process
(c) the natural drives of every human system
(d) conditioned reflexes installed by the present invention to respond to specific internal and external stimuli so discipline and/or a coach are not required for ongoing performance improvement
(e) a leadership development process which is also a personal development process motivated by self-interest and natural drives for self-expression, creativity, scaling new frontiers, the pursuit of knowledge, and new levels of achievement.

Prior Art 8: Leadership Development Ends when the Program Ends:

The input from traditional leadership development programs usually ends when the instruction ends. The instruction tends to focus on skills required to operate as a leader as the means to develop a leader. Occasionally there are coaching programs or, less frequently, action-learning programs tacked on after the formal instruction to try to sustain the material taught.

Invention Difference 8: Mechanisms for Future Leadership Development are Installed and Launched:

The focus of the invention is on installing the mechanisms for future leadership development. Its input therefore does not end when the instruction ends. The present invention installs the mechanisms to release leader meta-competencies, drives, dynamics, conditioned reflexes, identities, and modus operandi for life-long leadership development triggered by internal and external events and forces.

The invention launches a series of addicting growth continuums which are intrinsically rewarding and self-motivating: the more one pursues them, the more one wants to pursue them. The method of this invention imbeds conditioned reflexes and new modi operandi in response to specific environmental stimuli so it becomes a way of life. By installing conditioned reflexes for reacting differently to a variety of trigger events in reality, the dynamics and functionality of leaders continue to develop and amplify long after any formal program. The action-learning experimentation support program of this invention reinforces the mechanisms installed.

Accordingly, the invention lays the foundations for complying with nature-motivated evolution. Participants advance from manager to transitional leader to transformational leader to creational leader and frontiering leader as in FIG. 9 and to increasing impact and functionality based on the continuous amplification of dynamics inherent in the paradigm of this invention as in FIG. 10.

Prior Art 9: Providing Information to be Learned:

Most traditional programs seek to add new information to a student's existing system in order to improve leadership. According to the definitions below, said traditional programs promote ‘learning’ as opposed to ‘growth’ or ‘evolution’:
(a) ‘Learning’ adds information that can be used by one's existing system;
(b) ‘Growth’ advances one's performance to the full potential of one's existing system;
(c) ‘Evolution’ upgrades the baseline performance of one's existing system and advances it beyond its existing potential so one is functioning at a more powerful level and with more functionality.

Invention Difference 9: Evolutionary Mechanisms and Growth Continuums are Activated:

This invention promotes ‘evolution’ and ‘growth’ over ‘learning’. This invention is designed to tap into natural evolutionary forces within each human or social system. The paradigm shift of this invention incites life-long evolution since it installs conditioned reflexes, cultivates natural drives, and launches growth continuums that automatically advance individuals to a new level of performance and functionality each time they are used. They are intrinsically rewarding and self-motivating: the more one pursues them, the more one wants to pursue them.

This invention instills a drive to life-long accelerating evolution so that new functionality emerges continuously: the baseline of what is peak performance for the individual continually increases. With evolution, personal development, career development, and leadership development will advance in an integrated fashion as the baseline functionality and potential of the individual advances.

Prior Art 10: Unmotivated Leadership Development

Employees are not always as interested in pursuing leadership development as their employer is in addressing organizational leadership shortages. Therefore, offering employees programs which address their personal goals, interests and passions while instilling leadership as a byproduct would be ideal for meeting the goals of both.

Invention Difference 10: Motivated Leadership Development

The present invention is more attractive to employees than traditional leadership development programs because it provides leadership development as a byproduct of the program of this invention which also addresses: (a) life development (b) career development (c) personal development (d) pursuit of one's greatest life-time achievement (e) the pursuit of evolution, (f) operating perpetually from one's peak performance state, and (g) the pursuit of unity consciousness and the most evolved human states often embodied in religions or science.

In this way, the employer's goals for leadership development and amplification and employee peak performance are met through the same process as the goals an individual will be naturally driven to pursue. Accordingly, natural drives can be harnessed to achieve corporate goals with this invention.

Prior Art 11: Generic Leadership Development:

Most leadership development programs are generic: one size fits all.

Invention Difference 11: Personalized Leadership Development:

This invention provides a leadership development program that is fully customized and personalized through a combination of group and individual exercises:
(a) the natural core of any individual is the only logical foundation upon which to build leadership strength and greatness as an individual and a leader: the invention repositions individuals and systems led to their natural core,
(b) the dynamic leader foundation installed in each participant is customized to each individual's natural drives,
(c) historical life-themes such as knowledge-pursuit, creativity-pursuit, frontier-pursuit, and meaning-pursuit themes are projected into the future to define the participant's natural evolutionary path,
(d) five personal formulas are developed for each participant through the invention:
   (i) a personal evolution formula
   (ii) a personal leadership formula
   (iii) a personal leadership development formula
   (iv) greatest life-time performance formula as an individual
   (v) greatest life-time performance formula as a leader.
(e) the belief engineering methods of the present invention determine each participant's existing beliefs and changes them to preferred beliefs through the event-driven paradigm-based belief template upgrade method of the present invention.

Prior Art 12: Belief Engineering Expertise Plus a Belief System Upgrade are not Provided:

Few traditional leadership development programs put an emphasis on developing belief engineering skill for one's own system or systems led despite the criticality of a leader's beliefs and a leader's expertise in imprinting belief changes for impactful leadership. The clarity, consistency, and effectiveness of a leader's beliefs will determine his or her impact. If belief work is offered within a traditional leadership development program, it normally ends with the formal training program and thus will likely be forgotten once participants return to their work context.

Invention Difference 12: A Dynamic, Event-Driven, Belief System Upgrade Method for Both Leading and Leadership Development is Provided as the Basis for Developing the Belief Engineering Proficiency Found in Natural Leaders:

This invention develops belief engineering expertise. It provides an event-driven paradigm-based belief template upgrade method which continuously prompts belief changes as needed to advance the leader's own system or systems led such as follower systems, organizational systems, customer systems, and market systems.

This is another example of a mechanism installed by this invention which launches life-long leadership development and evolution. The benefits of the invention are launched by the formal program and then driven by internal and external events triggering conditioned reflexes for continuous evolution and enhancement.

The belief engineering expertise installed offers holistic systems-based belief management consistent with the logically integrated paradigm of this invention: the single systems-based modus operandi and toolkit of the paradigm of this invention is also applied to the management of systems of beliefs.

Human beliefs are always integrated into cohesive systems. Consequently, attempting to change one belief may be over-ridden by this integrating process. Therefore, for change management, one stable integrated belief system or template must be replaced by a new stable integrated system in its entirety. As a result, the invention has a belief template exchange process which exchanges one cohesive belief system with a new one as required to create the next reality for a system. This belief template exchange process is the essence of the paradigm-based quantum leap method of this invention. Belief changes and the resulting reality changes are the requisite proof that leadership has occurred in the paradigm of this invention. The degree of change in the 100% belief-created reality of the paradigm of this invention is the measure of the degree of leadership impact.

A strong, ‘unconflicted’, fully integrated belief template and the event-driven paradigm-based belief template upgrade method are critical to the achievement of the strength and consistency of leadership and hence critical to the leadership creation and development process of this invention. A pivotal quantum leap within this invention is to the “identity of leader” which is an example of a system of integrated beliefs. The paradigm itself is another system of beliefs.

Prior Art 13: Skill-by-Skill Development of Conceptual Competency

Increasing conceptual skills are required as leaders move up the hierarchy to more complex and expansive roles. In addition, the need for everyone to have better conceptual skills is increasing in what former Federal Chairman Alan Greenspan calls our “conceptual-based economy.”

Methods have not yet been invented to effectively develop conceptual skills in adult leaders. In the early nineties, the US army was just beginning to attempt it:

“Emerging leadership doctrine identifies three categories of competencies: technical, interpersonal communicative and conceptual. The Army has invested significant resources to design formal programs that develop the first two categories but has virtually ignored conceptual skills development.” . . . Historically, we have assumed that formal programs which develop conceptual skills were unnecessary. Our leaders generally could acquire the requisite skills on their own. Given the expected increases in operating tempo, battlespace and information in the 21 st century, it seems unlikely this strategy will adequately address our needs. (E. Kluever, W. Lynch, M. Matthies, T. Owens and J. Spears, 1992: 37)

Only a small percentage of leadership development programs take on the challenge of developing the conceptual and abstract skills critical to leadership roles especially at the executive level. Leadership programs tend to teach the technical and communication skills of leadership rather than the conceptual skills because the latter are more difficult. Those programs that attempt it tend to develop conceptual skills through modeling, role-playing, games, business case studies, business analysis, scenario analysis, experiential learning on the job, and coaching. Some just provide information about cognitive skills. Some build on the conceptual development approaches used to develop cognitive skills in children. As with other traditional leader skill development programs, the approach tends to fragment both the leader and the leadership process and target each conceptual skill as a separate standalone topic.

Conceptual competencies consist of the appropriate paradigms, mindsets, and conceptual skills (a) to assess the environment, (b) to see the long-range needs and implications of a situation and to build a plan for meeting these needs and (c) to visualize, address, and capitalize on the complex interrelationships that exist in a workplace in order to set priorities, make decisions, anticipate the future, and formulate strategies and tactics, and (d) to comprehend the culture of historically developed values, beliefs, and norms in order to visualize its future.

Conceptual skills include
(a) concept formation which is the capacity to analyze relationships between objects,
(b) abstraction or the ability to think symbolically,
(c) deductive logic which is the application of general rules or concepts in making a decision for a specific set of stimuli and/or
(d) inductive logic which is the analysis of feedback or identification of relevant details in formulating a concept to use in decision making,
(e) problem reframing to enhance creativity,
(f) dealing with multiple perspectives and ambiguity;
(g) frame of reference development including systems understanding, environmental scanning, pattern recognition,
(h) idea and concept development and use to solve complex problems,
(i) envisioning to anticipate the future,
(j) proactive thinking using critical, creative, reflective thinking,
(k) skillful formulation of ends, ways, means
(l) analysis of complicated events,
(m) trend perception,
(n) change detection,
(o) creative and opportunistic problem-solving,
(p) ability to conceptualize complex ideas,
(q) deployment of models, theories and inferences, and
(r) pattern recognition.

There is an increasing need for conceptual skills for leadership and for everyone:
(a) conceptual skills are prerequisites for leadership even more than technical and communication skills
(b) conceptual skills are the most difficult to develop
(c) conceptual skills make up more than 90% of the work of the more senior ranks of leaders. however, as the leadership function becomes distributed across many people in flat organizations versus being concentrated at the top, conceptual skills are becoming critical not just to competitive advantage but to survival.
(d) The retirement of baby-boomer executives is leaving a leadership shortage. Conceptual skills improve with age. With the age gap, there will be a conceptual skills gap as well.
(e) according to former Federal Chairman, Alan Greenspan, we have moved into a conceptual-based economy:
   (i) Jul. 11, 2000: “As the conceptual share of the value added in our economic processes expands further, the ability to think abstractly will be increasingly important across a broad range of professions. Critical awareness and the abilities to hypothesize, to interpret, and to communicate are essential elements of successful innovation in a conceptual-based economy.”
   (ii) May 13, 2004: “The world into which you graduate will require far greater conceptual skills than was required of your parents and grandparents. Productive and satisfying manual labor that engaged previous generations will become increasingly less available as technology substitutes for so many of those earlier skills. Your future incomes will depend on your conceptual abilities.”

Invention Difference 13: Holistic Installation of a System of Conceptual Meta-Competencies:

The present invention installs conceptual meta-competencies as an integrated system through the shift to the paradigm of this invention which partners an individual with nature's systems management process. This partnership:
(a) increases the immediate functionality of the individual
(b) evolves the baseline functionality of the individual
(c) allows individuals to operate beyond their immediate potential since there capabilities are augmented by nature's superior intelligence, information, creativity, power, and expanded perspective
(d) allows individuals to operate as if they have superior conceptual competencies without actually having them because of the increased information about how systems are co-evolving
(e) relieves individuals of the necessity of even developing solutions requiring conceptual capabilities in a number of situations. The paradigm of this invention reduces the number of one-off situations by taking a systems-based approach and linking all of those systems together in the integrated and synergistic flow to congruence, adaptation, advancement and co-evolution pursued by nature's systems management process.

Most of the challenges requiring conceptual competency relate to issues which are solved by forces attempting to bring systems individually and collectively to congruence. Partnering with this process will therefore reduce the demands for conceptual capability inherent in a leadership role. The reliance on an integrated systems perspective and the analysis of patterns stretches conceptual capabilities. The process of emergence combines existing information systems to create new information which provides creative solutions to challenges which previously relied on conceptual abilities.

Expanded consciousness is a faster, easier and more impactful route to the installation of conceptual competency than trying to build it up from standalone skills offered by traditional leadership programs. Consciousness spontaneously expands as individuals comply with the flow to generative congruence internally and externally promoted by the paradigm of this invention. A more expansive consciousness means more information about relationships and patterns is available to enhance conceptual functioning. Talent-based flow state is a peak performance and peak evolving state of altered consciousness promoted by this invention which also enhances conceptual results with each use and/or minimizes the need for them for the task at hand.

Prior Art 14: Skill-by-Skill Development of Emotional Intelligence Competencies:

Tom Peters prophesized that the successful companies in the next millennium, will be the ones that manage feelings best. This applies not just to the staff but also to the customer. Emotional intelligence may be the most critical component to leadership success. Daniel Goleman, author of “Emotional Intelligence” defines it as “the capacity for recognizing our own feelings and those of others, for motivating ourselves, and for managing emotions effectively in others and ourselves” . . . “Emotional Intelligence is a master aptitude, a capacity that profoundly affects all other abilities, either facilitating or interfering with them.” . . . “IQ and technical skills are important, but emotional intelligence is the sine qua non of leadership. When I compared star performers with average ones in senior leadership positions, nearly 90% of the difference in their profiles was attributable to emotional intelligence factors rather than cognitive abilities.”

Most traditional leadership development programs treat emotional intelligence as skills to be developed one-by-one until effective emotional intelligence is achieved. Common techniques for developing emotional intelligence include explanatory lectures, scenarios, individual and group analysis, work experiences, role-playing, and coaching.

Invention Difference 14: A System of Emotional Intelligence Meta-Competencies is Installed:

Dr. Goleman references five components of emotional intelligence: (a) knowing one's emotions (b) managing emotions (c) motivating oneself (d) recognizing emotions in others (e) handling relationships. Each of these can be achieved through the systems management process that is the foundation of this invention. Emotional intelligence emerges as a byproduct of the leader meta-competencies developed by the paradigm shift of this invention. The management of emotions identified in the five components can be viewed in terms of the systems integration, systems co-evolution, and flow to generative congruence promoted by the paradigm of this invention. Each individual, including the leader him/herself, is managed as all human systems are managed within this paradigm. Consequently, systems-based emotional intelligence is fully integrated into the invention as a byproduct.

The expanded consciousness that emerges from compliance with the flow to congruence that is a key characteristic of the paradigm of this invention offers more information and more solutions to any emotional rifts internally or externally. It is faster and easier to achieve expanded consciousness through this invention than to address a whole series of emotional intelligence skills separately in an ‘unintegrated’ fashion. This also means far fewer skill sets to be remembered with this invention. All human systems are handled identically with the same management strategies in the paradigm of this invention.

The paradigm also promotes operating 100% from flow state with extensive time in talent-based flow state a flow state in which one is creatively doing ‘work’ using one's greatest talents. Negative emotions characteristically cannot emerge within this flow state, resulting in an elimination of many situations requiring emotional intelligence. The event-driven paradigm-based belief template upgrade method that is a key component of this paradigm and is ongoing for all participants of this invention, automatically clears problem emotions with the replacement of the problem beliefs behind them.

A great many of the emotionally volatile situations which would require emotional intelligence competencies are also eliminated because participants comply with formulas consistent with how he/she should operate and evolve. Being in compliance with these formulas reduces strain on the system(s). Managing other systems in the same way minimizes the problem situations requiring emotionally intelligent solutions. In addition, even a person with a low emotional intelligence quotient (EQ) in most circumstances can suddenly have a high EQ when they are in the congruence promoted by this invention or when they are in talent-based flow or complying with the flow to generative congruence of their contextual system.

Prior Art 15: Skill-by-Skill Development of Learning Skills

With the onslaught of organizations trying to cultivate proficiency in learning, adapting and change, a small number of learning-to-learn or learning agility programs have recently begun to emerge. The learning technology is not yet available to make these programs impactful on organizational learning or creating the learning organization envisioned by Peter Senge from learning-agile employees.

Invention Difference 15: Learning Agility is a Byproduct of the Paradigm Shift of the Present Invention.

Learning to learn is one of the natural drives and meta-competencies that is released and augmented by the invention. This is achieved by a participant complying with the fundamental dynamics of the paradigm: the natural knowledge-pursuit, frontier-pursuit, creation-pursuit and meaning-pursuit themes of a participant's system. Said themes are indicators of the flow to generative congruence for the system internally and externally. Said themes also define the natural evolutionary path of the system that will be supported by natural mechanisms internally and externally. Said themes are the foundation of the personalization of the paradigm through the development of the five formulas: (i) personal evolution formula (ii) personal leadership formula (iii) personal leadership development formula (iv) formula for the greatest life-time performance goals as an individual (v) formula for the greatest life-time performance goals as a leader.

Learning to learn is built into the paradigm shift because the paradigm takes the risk out of learning by
(a) providing, in its singular focus on cultivating internal and external congruence, a single skill set that applies to most situations for adapting to, co-evolving with, or capitalizing on the advancement of all human systems relevant to the system to be developed or led;
(b) ensuring learning is aligned with the natural evolutionary path of the individual where it quickly becomes an addiction and a way of life that naturally spills over into other territories;
(c) increasing a participant's time in flow state which automatically advances an individual since one's capabilities must be stretched to enter flow state: in this way it has been the means by which the human race has always evolved;
(d) activating the natural drives for learning, knowledge, change, achievement, and flow state which is a state of perpetual learning;
(e) increasing learning resiliency and the ability to bounce back because the setbacks are part of a larger information messaging process which closes off wrong channels so right channels can be discovered;

Prior Art 16: Focused on how to do Leadership Activities

Invention Difference 16: Focused on Creating Leaders

### REFERENCE MATERIAL

Brown, R. B. (1993) ‘Meta-competence: a recipe for reframing the competence debate’, Personnel Review, 22, 6: 25-36.
Brown, R. B. (1994) ‘Reframing the competency debate: management knowledge and metacompetence in graduate education’, Management Learning, 25, 2: 289-299.
Cheetham, G. and Chivers, G. (1996) ‘Towards a holistic model of professional competence’, Journal of European Industrial Training, 20, 5: 20-30.
Cheetham, G. and Chivers, G. (1998) ‘The reflective (and competent) practitioner: a model of professional competence which seeks to harmonise the reflective practitioner and competence-based approaches’, Journal of European Industrial Training, 22, 7: 267-276.
Hall, D. T. (1986) Career Development in Organizations, San Francisco, Calif.: Jossey-Bass.
E. Kluever, W. Lynch, M. Matthies, T. Owens and J. Spears, “Striking a Balance in Leader Development A Case for Conceptual Competence,” National Serurity Program Discussion Paper Series 92-02 (Cambridge, Mass.: Harvard University, 1992), 37
Nordhaug, O. (1993) Human Capital in Organizations, Oslo: Scandinavian University Press. A Critical Overview, Coventry: Global Independent Research.
Snell, R. (1990) “‘Managers’ development of ethical awareness and personal morality”, Personnel Review, 19, 1: 13-20.
Webber, Alan M., Learning for a Change, by, Fast Company, Issue 24, May 1999, Page 178:

### BRIEF SUMMARY OF THE INVENTION

The present invention is a method for enhancing leadership, entrepreneurship, performance, innovation, creativity, and career achievement.

An integrated system of leader drives, reflexes, and meta-competencies are cultivated and/or installed to provide the dynamic underpinnings of leadership, entrepreneurship, peak performance, innovation, and career achievement.

Said system of drives, reflexes, and meta-competencies improves the assimilation and use of classic leader competencies taught by traditional leadership development and performance improvement programs to create more impactful leaders, entrepreneurs, innovators, individuals and human systems.

Said system is installed using a paradigm shift to a target paradigm composed of a logically integrated system of dynamics. Said dynamics pertain to how systems synergistically adapt, advance, and co-evolve to attain and sustain peak performance.

Said paradigm shift re-centers participants into congruence around their natural core since this is the only logical foundation upon which to build leadership strength and greatness as an individual and a leader. The dynamic leader foundation installed in each participant is customized to each individual's natural drives.

Said paradigm shift is achieved through a plurality of presentations, quantum leaps, belief upgrades, exercises, and action-learning experimentations which individually and collectively provide component systems of beliefs, dynamics, and information until the full paradigm has been completely assimilated. Said paradigm shift is designed to install a fully integrated replacement modus operandi for participants quickly and comprehensively rather than through a gradual transition.

The components of said plurality in many preferred embodiments are presented under these six subject categories: (i) the target paradigm (ii) the paradigm shift (iii) paradigm-based leadership (iv) personalizing the paradigm, (v) implementing paradigm-based leadership and (vi) action-learning experimentation.

The redefinition of leadership provided by this invention is based on a metaphor that both nature and natural leaders manage systems identically for survival, adaptation to environmental changes, advancement, co-evolution synergy, and peak performance. Said metaphor is captured in the systems-based paradigm of this invention which, as per the metaphor, mirrors and capitalizes on natural adaptive and generative processes internal and external to human systems.

Said redefinition identifies managers as those who manage what already exists, while leaders bring the unknown into existence as in creativity and innovation, or penetrate the unknown as in frontiering or pioneering. If there is no change in reality, leadership has not occurred.

Said metaphor allows the invention to provide a single systems-based approach and toolkit for advancing and leading all human systems whether those systems are the leader's own system or systems led such as follower systems, organizational systems, customer systems, and market systems, or processes viewed as systems such as leadership development, personal development, career development and organizational change management. This simplification is a key source of the power of this invention.

The invention offers automatic, nature-driven, development. The invention is designed to launch a series of self-motivating growth continuums and conditioned reflexes which harness natural mechanisms and drives to trigger life-long learning, personal development, leadership development, and career development for an individual, or the equivalent in human organizational systems led.

The paradigm prescribes that each person viewed as an individual system or organizational human system led comply with the natural flow to generative congruence of the system internally and the natural flow to generative congruence of the contextual system of which it is a part since it will be subject to the same pressures as said contextual system. The paradigm promotes complying with these two types of flow to congruence to capitalize on natural evolutionary forces acting on both systems to enable them to accelerate evolution. The flow to congruence powers the paradigm.

The advanced functionality of leaders and peak performers will emerge for each participant as each is advanced along his/her personal evolutionary path by complying with said flow to generative congruence. As an extension of said metaphor, the paradigm therefore merges leadership development or organizational development with the natural evolutionary continuum for the system to be developed or led.

To personalize both the paradigm shift and operating within the paradigm for each participant, the preferred embodiment promotes the identification of five personal formulas based on said flow to generative congruence: (i) a personal evolution formula (ii) a personal leadership formula (iii) a personal leadership development formula (iv) a formula for the greatest life-time performance goals as an individual, and (v) a formula for the greatest life-time performance goals as a leader.

Said flow to generative congruence is identified by historical patterns of events for each human system such as those indicating knowledge-pursuit, frontier-pursuit, learning-pursuit, creativity-pursuit, meaning-pursuit, resonance, positive emotion, spontaneous knowledge, spontaneous creativity, talent-based flow states, and projects requiring the application of an individual's key natural talents which were supported by a plurality of coincidences and flow events.

As said system of leader drives, reflexes, and meta-competencies strengthen through the invention, individuals evolve from managers who manage what exists to leaders who bring the new into existence through either creativity or penetrating new territory. They advance from managers to transitional change leaders to transformational change leaders and finally to creational and frontiering leaders. The natural core of each participant continuously expands in the process until s/he is impacting and influencing larger and larger territories.

Said integrated systems of dynamics composing the paradigm of the present invention which underpin said system of drives, reflexes, and meta-competencies of leaders, entrepreneurs, high achievers, and innovators include: a spontaneous self-organizing dynamic, a systems-based dynamic, a congruence dynamic, a templating dynamic, an emergence dynamic, a systems adaptation dynamic, a co-evolution dynamic, an expanding consciousness dynamic, a flow-within-flow dynamic whereby both the subsystem and its contextual system are in the flow to congruence, a quantum leap dynamic, a creation/creativity dynamic, a frontiering dynamic, a flow dynamic, an evolution dynamic, a knowledge-pursuit dynamic, and a frontiering dynamic.

Said paradigm of this invention is additionally defined as having a 100% belief-created reality in order to facilitate the development of the clarity and strength of beliefs necessary for leadership.

The plurality of said drives which link human systems to said flow to generative congruence and which are automatically amplified as a byproduct of operating in said paradigm includes: frontiering, change, achievement, creativity, creation, innovation, adaptation, learning, growth, resonance, congruence, self-expression, our peak-performance and peak-growth ‘flow state’ which is a state of consciousness that expresses physical, mental and emotional congruence, and, a drive to the ultimate congruence, that of expanded or unity consciousness.

Said meta-competencies resulting from said dynamics and said drives which enhance leadership, entrepreneurship, innovation, and peak performance include those relating to learning and learning agility, knowing, creating, frontiering, cognitive capabilities, accelerated growth, evolution, peak performance, talent-based flow, systems thinking, system-based emotional intelligence, expanding consciousness, expanding self-awareness and internal reference, expanding self-expression, continuous adaptation and re-optimization, co-evolution with contextual systems, fluidity, informationless decision-making, achievement and advancement by nonlinear quantum leaps, and accelerated implementation.

### OBJECTS OF THE PRESENT INVENTION

To Address the Leadership Shortage

An object of the present invention is to address the global leadership shortage due in part because of increased demand with greater market volatility and competitiveness, ineffective leadership development programs, and the pending massive retirement of baby boomers:
A further object of the present invention is to make traditional leadership development more effective:
   A further object of the present invention is to install within individuals a dynamic leader infrastructure or framework of leader drives, reflexes, and meta-competencies which can better assimilate and use the classic leader competencies promoted by traditional leadership development programs.
   A further object of the present invention is to use a holistic systems-based approach to leadership and personal development so as to permit massive upgrades to performance and functionality quickly.
A further object of the present invention is simultaneous leader creation, development, empowerment, peak performance, and peak career achievement.
A further object of the present invention is to provide a nature-driven, natural leadership development process.
A further object of the present invention is to provide an intrinsically rewarding, self-motivating, leadership development process which generates leadership as a byproduct of selfishly pursuing one's natural evolutionary path to career peak achievement or doing what one is naturally driven to do.
A further object of the present invention is to use employer and employee goals as the fodder for action learning to accelerate the assimilation of leader dynamics, drives, reflexes and meta-competencies.
A further object of the present invention is to install a powerful toolkit and a predisposition for, if not an addiction to, penetrating the unknown as in frontiering or bringing the unknown into existence as in creation, creativity, and innovation.
A further object of the present invention is to provide belief engineering expertise and an event-driven paradigm-based belief template upgrade method which ensures not only the strength and clarity of beliefs as required within the leader but the ability to imprint and cultivate them in the individual and organizational systems led.
The invention has the further object of a redefinition of leadership into a paradigm in which all systems are fully integrated into the adaptive, co-evolving flow of nature so that leaders can augment their capabilities by capitalizing on nature's superior systems management process.
A further object of the present invention is to provide customized leadership and personal development.
A further object of the present invention is to address the need for sustainable leadership development that goes beyond the boundaries of the classroom:
   A further object of the present invention is to launch a series of natural growth continuums through drives and conditioned reflexes that are continuously triggered by natural mechanisms and events internally and externally to incite life-long leadership development.

To Address the Conceptual Skills Shortage

A further object of the present invention is to address the existing and pending conceptual skills shortage due in part to (a) the leadership shortage since conceptual skills comprise 90% of the work of senior ranks and are ranked more important than technical and communication skills, (b) the need for the distribution of leadership across many people in the new flat organizations, (c) the massive retirement of the baby boomers since conceptual skills improve with age, and there will be an age gap (d) we have moved into a conceptual-age economy, (see Background: Prior Art 13 for details), and (e) conceptual skills are the most difficult to develop.
A further object of the present invention is to address the pending conceptual skills gap by cultivating conceptual skills and by offering the means to bypass the need for them.
A further object of the present invention is the holistic installation of an integrated system of conceptual meta-competencies.

To Address Productivity Improvement Demands

A further object of the present invention is to address the need for peak performance and maximum productivity from employees:
A further object of the present invention is to promote accelerating evolution which constantly improves the baseline functionality of the individual without having to address each component capability.
A further object of the present invention is to promote talent-based flow state—the peak-performance and peak-evolving state—for the individual's system and all systems being led.
   A further object of the present invention is to launch a talent-based flow continuum which will enable participants to eventually exceed the flow states defined by Mihaly Csikszentmihalyi, author of ‘Flow’ (1991) and which is based on the sustained experience of flow state around doing ‘work’ that uses an individual's key talents to the maximum for creative expression or creation.
   A further object of the present invention is to promote flow-within-flow whereby the individual or subsystem operates in talent-based flow state in compliance with the talent-based flow of the contextual system thus synergistically co-evolving with other subsystems share the same context.
A further object of the present invention is to improve the baseline functionality of individuals immediately and for a life time by launching natural growth continuums that will advance functionality much more quickly than without the intervention.
A further object of the present invention is to addressing the shortage of entrepreneuring, intrapreneuring, innovation, and frontiering or pioneering skills which are change management skills related to either penetrating the unknown or bringing the unknown into existence.
   A further object of the present invention is to make leadership, entrepreneurship, creativity, innovation, pioneering and a passion for penetrating the unknown or bringing the unknown into existence the inevitable byproduct natural growth paths, learning paths, and evolutionary paths that an individual would pursue anyway given the freedom and resources.

To Address the Challenges of the Talent Wars

### The invention has the further object of addressing the blended needs arising from the talent wars and the trend towards career self-management for a career process which co-evolves the company and the individual to the advantage of both.

To Achieve Dramatic Transformation Quickly

A further object of the present invention is to achieve dramatic and nonlinear transformation by installing a plurality of leader meta-competencies as a single integrated system through a paradigm shift or quantum leap rather than having to cultivate them individually.

To Achieve this Dramatic Transformation Safely

### A further object of the present invention is to achieve this dramatic transformation safely by inciting a quantum leap nonlinearly from one stable state to the next without having to stay safe through unstable linear transition states.

To Achieve Dramatic Transformation Simply

A further object of the present invention is to provide a single systems-based approach, skill set, and toolkit for advancing and leading all human systems whether those systems are the leader's own system or systems led such as follower systems, organizational systems, customer systems, market systems or processes viewed as systems such as leadership, personal, organizational, and career development, and change management.

To Capitalize on Natural Processes

### A further object of the present invention is to capitalize on natural growth, motivation, and evolutionary processes, mechanism and strengths to accelerate the natural processes that create and empower natural leaders, individuals and organizations.

A further object of the present invention is to release drives and reflexes that have been culturally suppressed which frees individuals to return to an evolutionary continuum which is also the leadership development continuum.

The reader skilled in the art will recognize other objects and advantages of the present invention, from the brief description of the drawings, the detailed description of the invention, and the appended claims.

### BRIEF DESCRIPTION OF THE DRAWINGS

The foregoing brief description, as well as other features and advantages of the present invention will be understood more completely from the following detailed description of a preferred embodiment, with reference being had to the accompanying drawings. Understanding that these drawings depict only typical embodiments of the invention and are not therefore to be considered to be limiting of its scope, the invention will be described and explained with additional specificity and detail through the use of the accompanying drawings.

The drawings for the present invention have been divided into the key subject categories which have been used throughout this invention, said subject categories comprising (a) the target paradigm (b) the paradigm shift (c) paradigm-based leadership development (d) personalizing the paradigm (e) implementing paradigm-based leadership (f) action-learning experimentation, and (g) invention overview. Said drawings comprising:

The Target Paradigm

FIG. 1 is a chart of the key components of the integrated target paradigm of the present invention illustrating a single cohesive object state or system.

FIG. 2 is a diagram illustrating the paradigm shift to internal congruence around the natural core of a human system that is promoted by the present invention as the only foundation for full strength as a leader, an individual, and a human system. Once internal congruence is achieved, advancement is an expansion or intensification of that congruent core. The perpetual and generative flow to human system congruence is harnessed by the present invention for both leadership development and leading systems.

FIG. 3 is a diagram illustrating the flow of co-evolving subsystems to the natural core or naturality of their shared contextual system to achieve external congruence. It is this flow to external congruence that powers the dynamics of the paradigm of the present invention which lead to the amplification of leader drives, reflexes and meta-competencies promoted by the invention.

FIG. 4 is a chart illustrating that the paradigm reactivates leader drives which have been suppressed by cultural interference. The objects of the invention are achieved through leveraging natural drives, dynamics, and forces integrated into the paradigm of this invention.

FIG. 5 is a diagram that illustrates that the belief blueprint or template of a system creates everything in its internal and external reality making the system and its reality a single system which can be advanced by template exchanges or quantum leaps. Since beliefs create reality, what beliefs are in the template are known by the events in internal or external reality. Change beliefs to change reality for an individual's development or for organizational change leadership.

The Paradigm Shift

FIG. 6 is a diagram illustrating the paradigm shift and thus the structure of the method of the invention: quantum leaps are used to internalize subsets of an integrated paradigm belief system which results in the integrated system of leader drives, dynamics, reflexes, and meta-competencies that are the object of this invention.

FIG. 7 is a diagram illustrating the dynamic anatomy of the quantum leap or template exchange method critical to both the paradigm shift and operating in the paradigm of the present invention. It is the means to nonlinearly reincarnate at a more advanced state.

FIG. 8 is a chart highlighting the steps to take in the quantum leap or paradigm shift process of the present invention.

Paradigm-Based Leadership Development

FIG. 9 is a diagram indicating a paradigm-based leadership development continuum defined by the amplification of key drives and dynamics integrated into the paradigm of this invention. Said amplification is also built into the dynamics of the paradigm so that leadership development is merged with a natural evolutionary process.

FIG. 10 is diagram indicating a different paradigm-based leadership development continuum operating within the paradigm of this invention, this time based on the evolutionary direction built into the paradigm of expanding a system around its natural core or natural congruence. Expansion means that increasingly larger territories will be impacted by the amplification of the same belief management process and dynamics used on smaller realities. Again, said amplification is built into the dynamics of the paradigm so leadership development and natural evolutionary progress are one and the same.

Personalizing the Paradigm

FIG. 11 is a chart identifying the patterns of events indicative of the flow to congruence internally and externally which are tracked in order to determine a participant's five personal formulas for capitalizing on said flow to generative congruence internally and externally within the paradigm of this invention.

FIG. 12 is a chart of exercises which provide information in addition to the patterns of events tracked in FIG. 11 for determining a participant's key themes and personal evolution formula upon which the other four personal formulas are based.

FIG. 13 is a diagram of the event-driven paradigm-based upgrade method which provides a paradigm-based belief engineering technology which is used for leadership development, leading, and upgrading and co-evolving any human systems. The benefits of said method are listed.

FIG. 14 is a chart of a common conflicting belief complex to help individuals identify problem beliefs for the event-driven paradigm-based belief template upgrade exercises.

Implementing Paradigm-Based Leadership

No drawings

Action-Learning Experimentation

No drawings

Invention Overview

FIG. 15 is a chart listing the presentations of a preferred embodiment of the formal program of the method of the present invention provided in order to better understand said method.

### PREFERRED EMBODIMENT OF THE PRESENT INVENTION

A preferred embodiment of the present invention in which exclusive property or privilege is claimed follows.

Many of the above-noted objects can be achieved through the following preferred embodiment of the present invention. The described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

A Method for Enhancing Leadership, Entrepreneurship, Performance, Innovation, Creativity, and Career Achievement.

The present invention provides a method for enhancing leadership, entrepreneurship, performance, innovation, creativity, and career achievement.

An integrated system of drives, reflexes, and meta-competencies are cultivated and/or installed to provide the dynamic underpinnings of leaders, entrepreneurs, high achievers, and innovators. Said system is installed using a paradigm shift to a target paradigm composed of a logically integrated system of dynamics. Said dynamics pertain to how systems synergistically adapt, advance and co-evolve to attain and sustain peak performance.

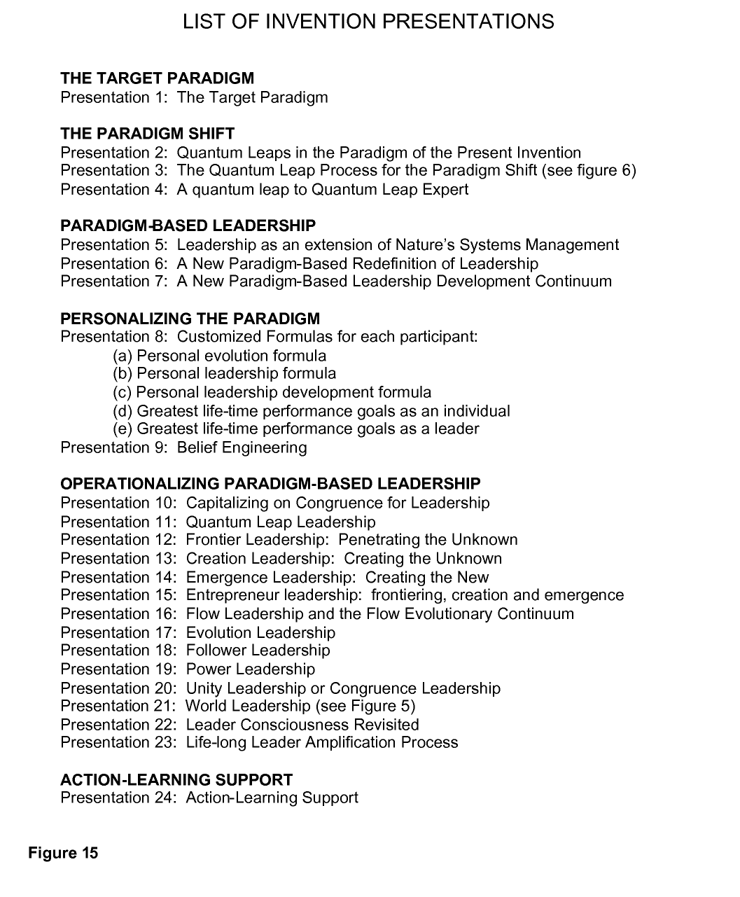

Said paradigm shift is achieved using a plurality of (a) presentations (b) quantum leaps (c) belief upgrades (d) individual and group exercises, and (e) action-learning experimentation. Said plurality installs a series of component systems of beliefs, information, and dynamics of which the target paradigm is composed until the whole target paradigm has been completely assimilated. Said presentations have been listed in FIG. 15 to permit a quicker grasp of the preferred embodiment presented below.

Said dynamic underpinnings improve the assimilation and use of classic leader competencies taught by traditional leadership development and performance improvement programs to create more impactful leaders, entrepreneurs, innovators, individuals and human systems.

The invention launches a series of self-motivating growth continuums and conditioned reflexes which harness natural mechanisms and drives to trigger life-long learning, personal development, leadership development, and career development or the equivalent in human organizational systems led.

The below preferred embodiment of this invention is comprised of the six subject categories used throughout this invention: (a) the target paradigm (b) the paradigm shift (c) paradigm-based leadership (d) personalizing the paradigm, (e) implementing paradigm-based leadership, and (f) action-learning experimentation.

The Target Paradigm

Presentation 1: The Target Paradigm

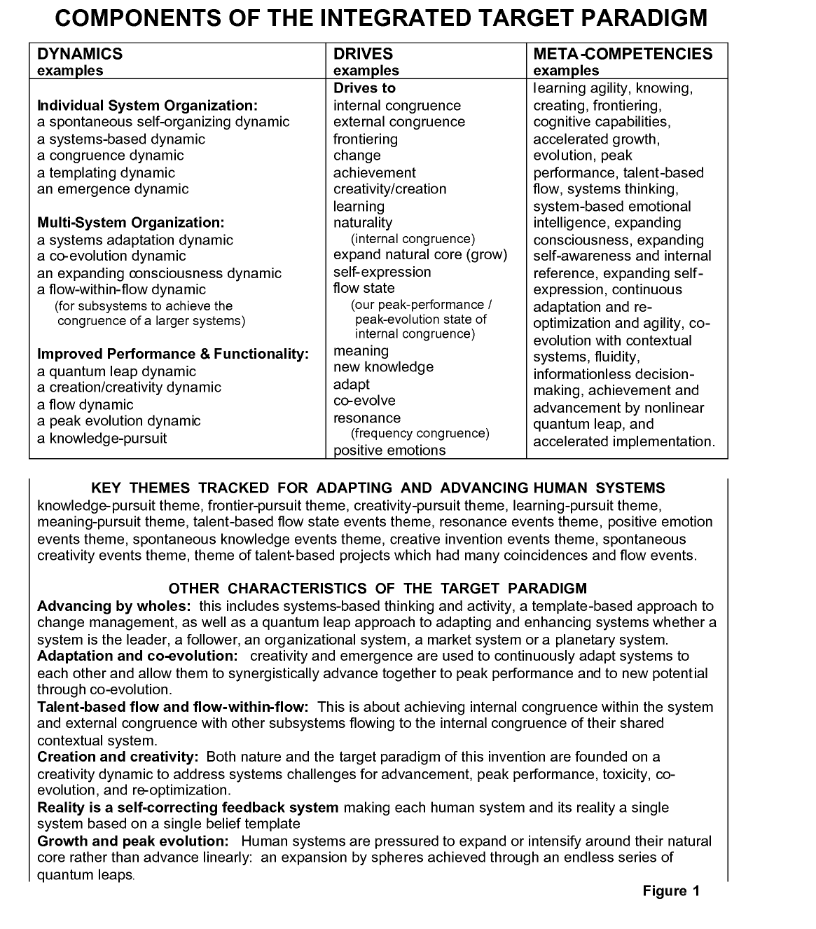

Interactive instructor presentations or pre-recorded media presentations describe nature's systems management process since the target paradigm of this invention metaphorically mirrors and extends this systems-based process for leading, leadership development, personal development, and peak performance. FIG. 1 introduces the key elements of the integrated target paradigm covered: the dynamics, drives, meta-competencies, the key themes tracked for adapting and advancing human systems, and other characteristics of the target paradigm.

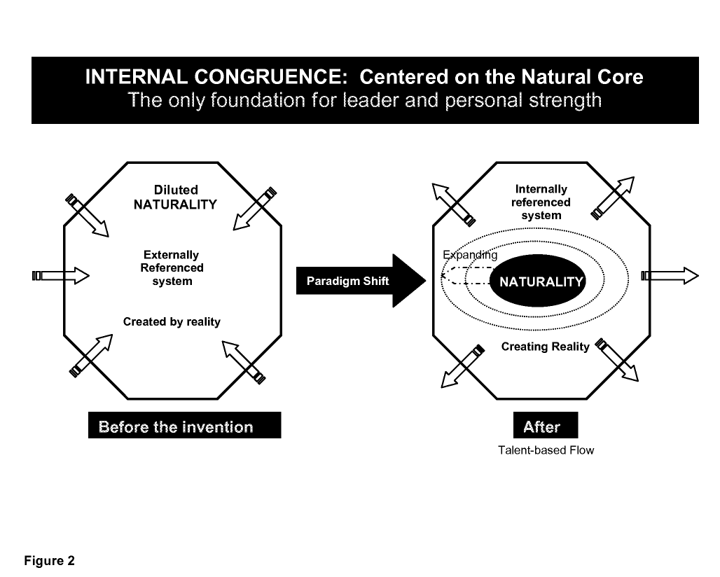

There are two key underlying dynamics operating within the target paradigm to which everything else is attached. FIG. 2 illustrates the first key underlying dynamic: the flow to internal congruence of any human system to its natural core and belief template that defines each system. It illustrates the shift from externally referenced and created by one's reality to internally referenced and creating one's reality, a shift pivotal to the creation and empowerment of leaders. In addition, it demonstrates that the empowerment of a human system relies on the expansion of that natural core by spheres rather than a linear process from point A to point B.

FIG. 2 holds true for every human system whether it is the leader's own system, a follower's system, an organizational system, a market system, a customer system, or a process system such as leadership development, career development or organizational change. Therefore every human system can be advanced identically or with the same single set of paradigm-based tools in the target paradigm of the present invention.

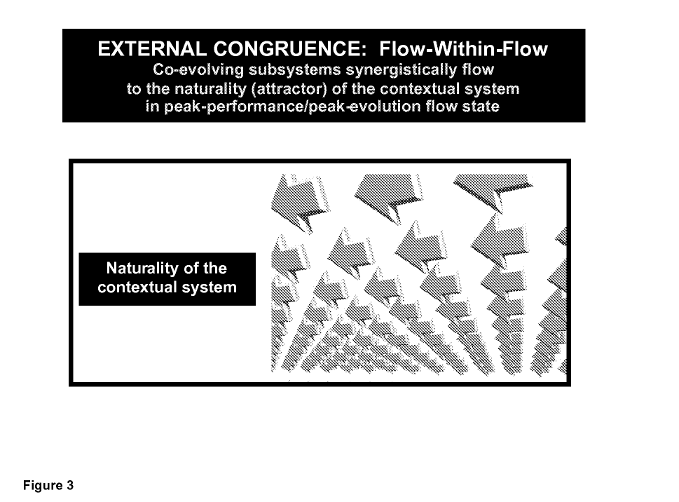

FIG. 3 indicates the second key dynamic underpinning the target paradigm: the flow to external congruence of any human system. The state of peak performance and evolution for every human system is flow state (Csikszentmihalyi, Flow, 1990). This is the state of congruence for each system. Since every human system is a subsystem of a larger contextual system, the ideal peak performance state would be achieved if both the subsystem and the contextual system were in flow state. Ideally all subsystems would merge with and capitalize on this flow-within-flow to synergistically adapt and co-evolve.

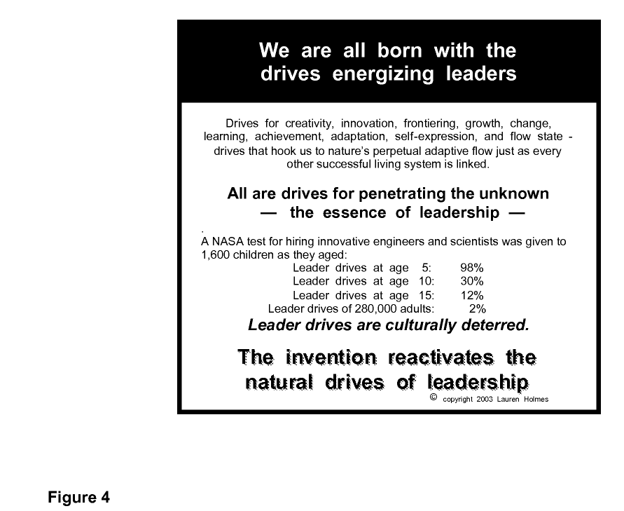

The target paradigm is designed to launch natural mechanisms for life-long growth, learning and evolution. FIG. 4 demonstrates that we are all born with leader drives which are then suppressed with cultural indoctrination. The target paradigm reactivates and strengthens these leader drives.

Presentation 2: Quantum Leaps in the Target Paradigm of the Present Invention

An interactive instructor presentation or pre-recorded media presentation explains the quantum leap dynamic and how quantum leaps integrate into the target paradigm of the present invention. Topics include:
(a) what quantum leaps are,
(b) why quantum leaps are nature's preferred method of adapting and advancing systems,
(c) the need for quantum leaps,
(d) the purpose of quantum leaps,
(e) the direction of quantum leaps,
(f) the uses of quantum leaps,
(g) the template-rewrite process that underpins quantum leaps
(h) the types of quantum leaps,
(i) how to increase the speed and magnitude of quantum leaps,
(j) the need for routine, continuous ‘quantum leaping’ to adapt to and advance synergistically with co-evolving systems sharing the context,
(k) how to speed change and progress and improve performance by harnessing nature's perpetual quantum leap dynamic; and
(l) the progression of expertise in orchestrating quantum leaps that one can expect.

The present invention puts quantum leaps into an actionable form by redefining them in the target paradigm as:
(a) a belief template exchange of the pre-leap template for the post-leap template which causes a reality exchange by reflection in the belief-created reality of the target paradigm;
(b) an integrated and cohesive set of belief changes which send an integrated set of new instructions to reality;
(c) the process of emergence in which existing internal and external systems of information are recombined to create new information which is greater than the sum of its parts to be inserted into the new post-leap belief template;
(d) the incorporation of new information into a system's belief template as new beliefs;
(e) nature's adjustments of systems from one stable state to a better stable state in the process of re-optimizing them into a new level of congruence internally and/or externally;
(f) spontaneous system self-reorganization; and
(g) system reincarnation at a more advanced state of congruence.

The exchange of the pre-leap belief template for the post-leap belief template required for a quantum leap can be an abrupt, instantaneous event, or a process that takes days or months depending on the magnitude of the belief changes required. Beliefs and genes are the information storage units that define a human system. Therefore belief changes require the sourcing and storage of new information into the system which may take time.

Because quantum leaps are nature's adjustments of systems into a new level of congruence internally and externally, the flow of all systems to generative congruence can be used to power the quantum leap emergence process. Therefore, all attempts to quantum leap in the paradigm of this invention must integrate with the flow to congruence until emergence causes spontaneous self-reorganization at a new post-leap state as identified above and in FIGS. 2 and 3.

An object of this invention then is to capitalize on the emergence process that is always advancing and adapting systems for new levels of congruence to change the pre-leap belief template to the post-leap template. The philosophy behind the paradigm-based quantum leap method of this invention is that it is easier to partner with nature's intelligence, expertise, and powerful forces than to try to duplicate them.

The Paradigm Shift

Presentation 3: The Paradigm-Based Quantum Leap Method for Both the Paradigm Shift and Operating in the Target Paradigm

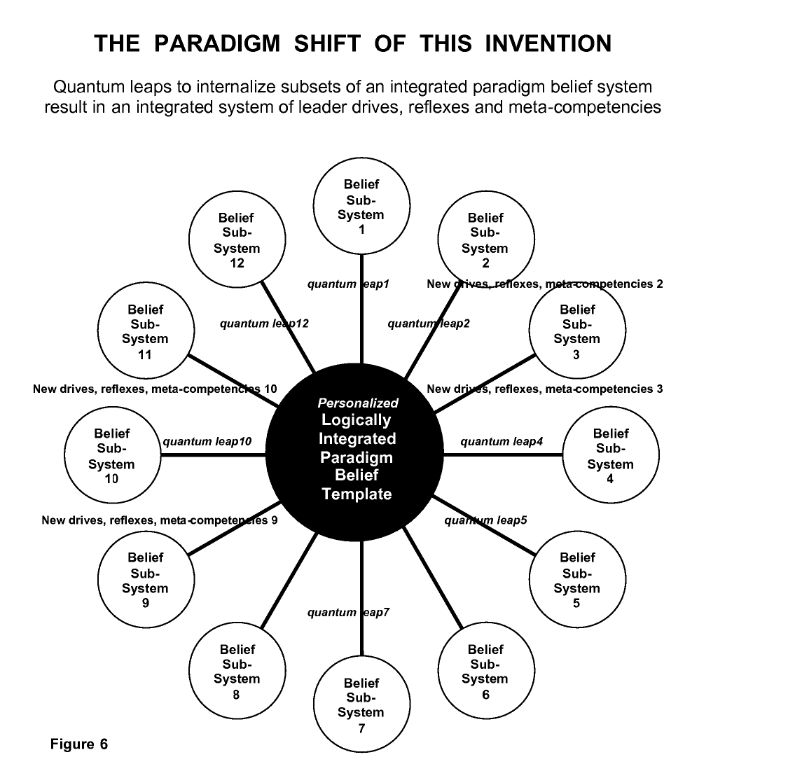

An interactive instructor presentation or pre-recorded media presentation explains the paradigm shift process of the present invention. FIG. 6 illustrates that all of the beliefs required to operate in the target paradigm are internalized as a series of subsystems. Each subsystem is internalized by a quantum leap or belief template exchange until each participant has assimilated the logically integrated belief template that defines the entire target paradigm. Said template is the dynamic foundation for installing, releasing, reactivating, and empowering the drives, reflexes and meta-competencies of leaders, entrepreneurs, and innovators that is the key object of this invention.

The paradigm shift is itself a quantum leap which is achieved through a series of smaller quantum leaps. Because the target paradigm is logically integrated, every part can be deduced from every other part. As the paradigm shift proceeds through this invention, participants eventually internalize a critical mass of beliefs about the target paradigm which allows them to shift or quantum leap to having internalized the entire target paradigm. The overwhelming logic of the paradigm persuades individuals to make it their founding modus operandi for the rest of their lives.

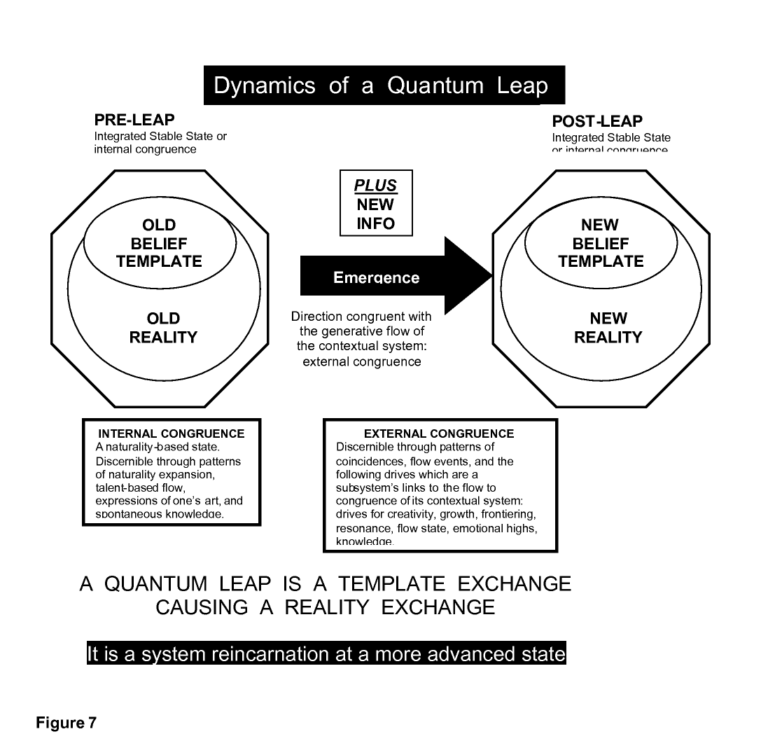

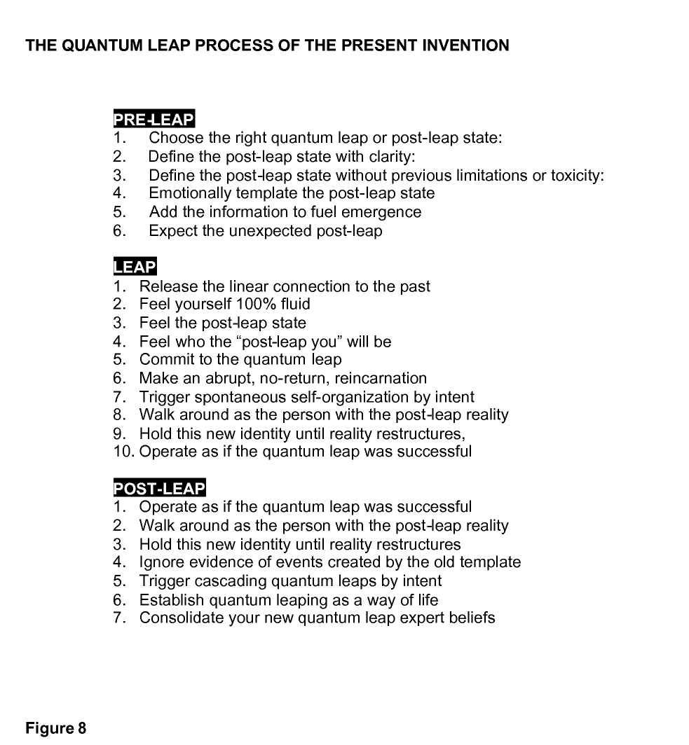

An interactive instructor presentation or pre-recorded media presentation explains the steps of the paradigm-based quantum leap method of the present invention and how to install quantum-leap expertise as a conditioned reflex to facilitate the rest of the quantum leaps required for the paradigm shift and the quantum leap modus operandi required to operate within said paradigm going forward. The dynamic anatomy of a quantum leap is illustrated in FIG. 7 and the component steps are identified in FIG. 8. A quantum leap is a belief template exchange causing a reality exchange. It is a system reincarnation at a more advanced state.

The paradigm-based quantum leap method of this invention applies to any system in the target paradigm of this invention such as an individual, a leader, the leadership or personal or career development process, an organizational system, a market system, or the globe. Quantum leaps advance systems from one stable congruent state to a more adaptive or advanced stable congruent state.

The pre-leap is comprised of these steps: (a) choose the right quantum leap or post-leap state based on the flow to congruence (b) define the post-leap state with clarity (c) define the post-leap state without previous limitations or toxicity (d) emotionally template the post-leap state by visualizing to the point of experiencing the object emotions of having the post-leap reality (e) add the new information from the invention presentations to the pre-leap belief template required to fuel the emergence process to generate a replacement post-leap belief template (f) expect the unexpected post-leap since quantum leaps are usually nonlinear due to emergence and thus cannot be anticipated as a logical, linear projection of the pre-leap state.

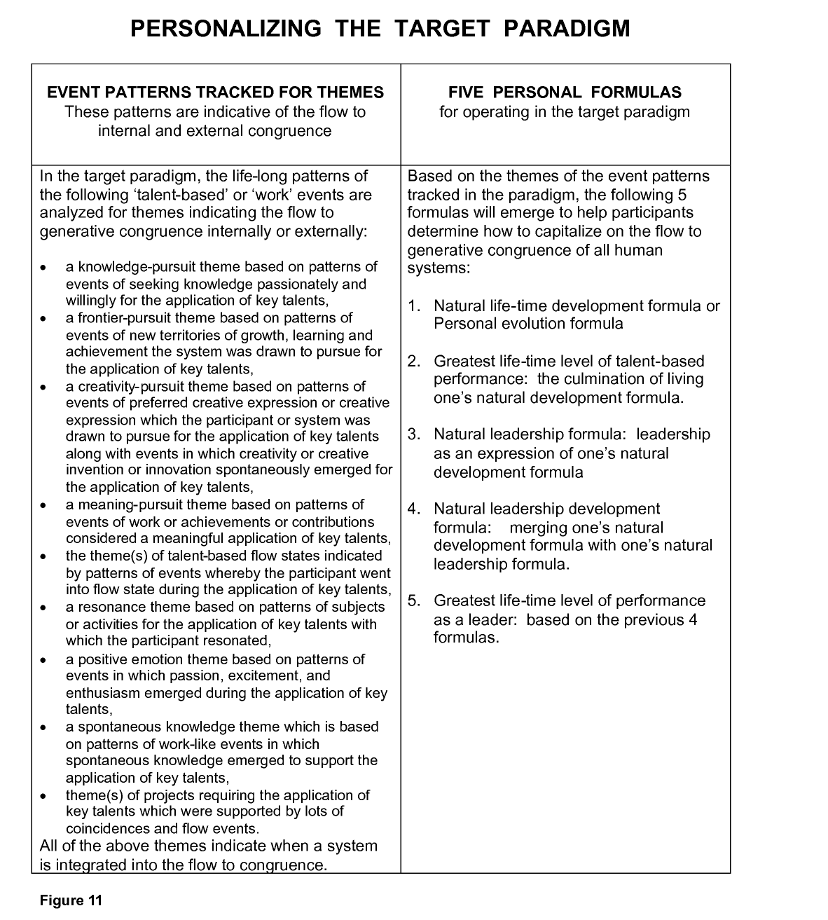

All quantum leaps in the target paradigm need to be chosen in the direction of the flow to generative congruence internally and externally that is illustrated in FIGS. 2 and 3 in order to capitalize on natural mechanisms such as adaptation, synergy, co-evolution, emergence, and coincidences inherent in human systems. The direction of the flow to internal congruence can be determined by examining the event patterns tracked for themes in FIG. 11. The direction of the flow to external congruence can be determined from the following historical patterns of one's system or the system led: patterns of coincidence clusters, flow events, internal drives for creativity, growth, frontiering, resonance, flow state, emotional highs, knowledge, and quantum leaps. These human drives are a subsystem's links to the flow to congruence of its contextual system and thus indicate the flow to external congruence for the subsystem.

Post-leaps can be defined in terms of beliefs, emotions, congruence, new information or as an expressed identity system of beliefs. By definition, quantum leaps exchange one stable state for another so the target post-leap state needs to be equally as integrated, stable and congruent as the pre-leap. Post-leaps do not need to be a linear extension of pre-leaps.

The leap is comprised of these steps: (a) release the linear connection to the past (b) feel yourself 100% fluid (c) feel the post-leap state (d) feel who you will be post-leap (e) commit to the quantum leap (f) make an abrupt, no-return, reincarnation (g) trigger spontaneous self-organization by intent.

The post-leap is comprised of these steps: (a) operate as if the quantum leap was successful (b) walk around as the person with the post-leap reality (c) hold this new identity until reality restructures (d) ignore evidence of events created by the pre-leap belief template (e) trigger cascading quantum leaps by intent (f) establish quantum leaping as a way of life (g) consolidate and internalize experiential learning as new quantum leap expertise beliefs and conditioned reflexes based on this successful quantum leap in order to improve future quantum leaps.

Presentation 4: The Quantum Leap to Quantum Leap Expert

The paradigm-based quantum leap method presented in Presentation 3 is used to trigger a quantum leap to the identity of a quantum leap expert with the belief template, conditioned reflexes, experiential learning, fluidity, and emotional memory of the process to not only effectively accomplish all of the quantum leaps in the formal program of the invention but the ongoing personal quantum leaps of one's own system or systems led necessary to operating with the flow to generative congruence underpinning the target paradigm. This first quantum leap of the invention lays the foundations for excelling at all of the other quantum leaps in the invention.

Full-class quantum leap 1: A quantum leap to quantum leap expert who routinely advances him/herself or the systems in their reality by wholes from one stable state to the next through a template exchange process.

Paradigm-Based Leadership

Presentation 5: Leadership as an Extension of Nature's Systems Management

An interactive instructor presentation or pre-recorded media presentation from a big-picture perspective demonstrates how leadership mirrors and is an extension of nature's systems management process described in Presentation 1. Natural leaders capitalize on natural forces which have evolved to adapt, advance, and co-evolve systems to increase generative congruence, whether that system is the leader's own system, or that of a follower, an organization, a market system, or processes such as leadership development and career development.

Full-class exercise 1: The group is challenged to prove that classic leadership competencies are not promoting internal or external systems congruence as proposed by the paradigm of this invention as a means to prove that the opposite is true. With this proof that the paradigm of this invention is an accurate representation of leadership, a group exercise is launched to define leadership from this big-picture perspective.

The components of the integrated target paradigm identified in FIG. 1 are dynamics, drives, meta-competencies, themes and other paradigm characteristics. (a) Said components are translated into the role of leader or entrepreneur or career peak performance as appropriate. (b) How leader drives, reflexes and meta-competencies are developed is explained as well as (c) how growth continuums for them are launched. (d) How the paradigm-based quantum leap method of this invention will be used to advance participants or the systems they lead is also presented.

Full-class quantum leap 2: A quantum leap to the paradigm-based perspective and consciousness of leadership and entrepreneurship that has been presented.

Presentation 6: A New Paradigm-Based Redefinition of Leadership

This presentation deepens the perspective provided by Presentation 5 into more practical and tactical terms. An interactive instructor presentation or pre-recorded media presentation redefines leadership and the work of a leader in terms of the systems-based, congruence-based dynamics of the target paradigm of this invention. This paradigm-based redefinition of leadership is explored in terms of the (a) identity of ‘leader’, (b) leader creation, (c) a new leadership development continuum, (d) leader versus manager, (e) the leader-manager partnership, (f) leader-human evolution, (g) the leader drives, (h) the leader reflex, (i) the leader zone, and (j) leader consciousness.

Manager versus Leader Redefinitions: Creativity is required for every system adaptation and advancement to new levels of congruence in the paradigm. Leadership will therefore be a creative act. In a paradigm where creativity is the underlying dynamic for ongoing problem-solving in advancing and adapting systems, the distinction between leaders and managers becomes obvious: Managers manage the known. They run existing realities. Leaders bring new realities into existence. Theirs is the world of the new, the unknown, the ambiguous. New creations, new beliefs, and new strategies create new realities through leadership. New territory is conquered. The degree of ‘new creation’ that a leader brings to an existing reality is the measure of his or her leadership strength. The leader-manager partnership then is one in which leaders bring new systems and territories into existence and managers run them. Organizations need both.

Leaders are masters of the unknown. By the new definition of leadership in the natural leader paradigm below, leadership has not occurred without either of these 2 forms of mastering the unknown: (a) penetration of the unknown which includes frontiering, learning, growth, informationless decision-making, expanded consciousness, adaptability, agility, knowing, and systems thinking or (b) bringing the unknown into existence such as through creation, innovation, creativity, self-expression, achievement, talent-based flow, and peak performance. Given the premise that if there is no new reality, leadership has not occurred, the complex of drives and meta-competencies surrounding both the expertise in and addiction for penetrating the unknown is a key object of the present invention.

Full-class quantum leap 3: A quantum leap to the identity of leader. Identities are a quick way to internalize an integrated system of beliefs. Post leap: Allow others to now recognize and accept your new identity.

Leader Zone: If leaders are defined on the basis of their ability to use frontiering, creativity, emergence, flow, co-evolution, and quantum leaping in order to bring new realities into being, then the domain of leadership within the target paradigm becomes very precisely demarcated. By definition, leaders operate in the gap between current reality and the new reality they are trying to bring into existence. The leader zone represents any context where creativity is resolving the adaptation, congruence, or generative challenges of systems. The paradigm shift enables participants to not only master the leader zone where the frontiering and creativity of adapting systems are occurring but also become addicted to it. The person comfortable penetrating the unknown and proficient at it will always be the leader.

Leader Reflexes: A reflex is an involuntary and often instinctive behaviour in response to a stimulus. With the paradigm shift of the present invention, participants become so proficient at frontiering, creation, emergence, change, and championing the co-adaptation process of co-evolving systems that they gain a new repertoire of reflex reactions so that leadership can become instinctive and automatic.

Leader Consciousness: Expanding consciousness or expanding perspective is built into the paradigm of the present invention. As one merges with the flow to generative congruence, and gains experience and expertise in managing co-evolving systems, unity consciousness will gradually emerge. The added functionality of this meta-competency informs all other leadership skills to upgrade leader performance on every front: (a) The potential for proactive synergy becomes more obvious. Unity consciousness, non-dual consciousness, expanded consciousness, and systems thinking allow leaders to see the co-evolution of multiple systems inside and outside of the organization in order to determine the ideal direction in which to lead and to harness the synergy possible in an integrated process that is already occurring. (b) Leaders must unify. Unification is more effectively accomplished from a state of unity consciousness than from fragmentation. Cultivating flow consciousness in themselves and in their followers will ensure peak performance in implementing the perceived new directions

Full-class quantum leap 4: A quantum leap to an identity which includes both you and everything in your belief-created reality. You and reality are a single system managed by a single belief template which you control. Extend your identity to all you can perceive.

Full-class quantum leap 5: A quantum leap from externally referenced to internally referenced, from being created by your reality to creating your reality.

Full-class quantum leap 6: A quantum leap to internalizing yourself and your followers as a single system which you own and direct.

Presentation 7: A New Paradigm-Based Leadership Development Process

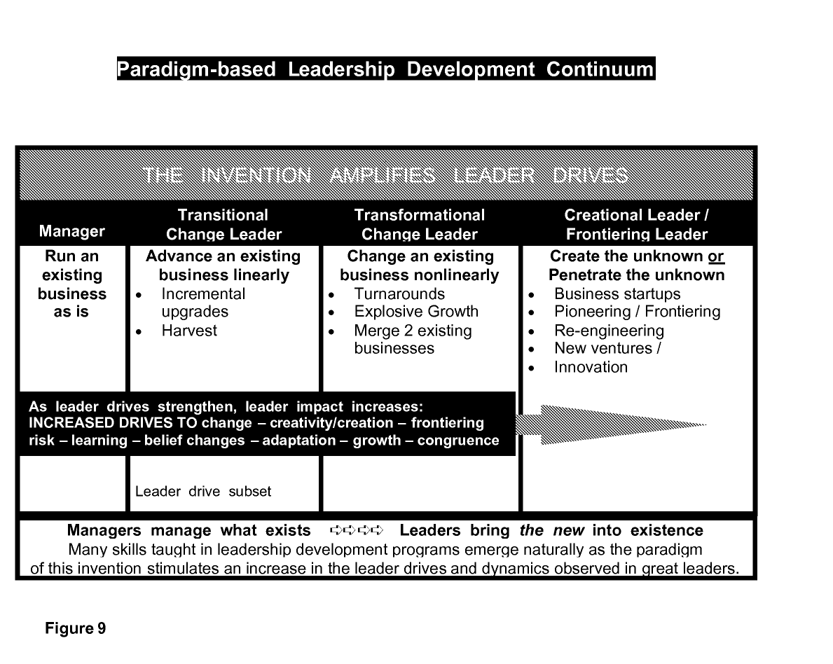

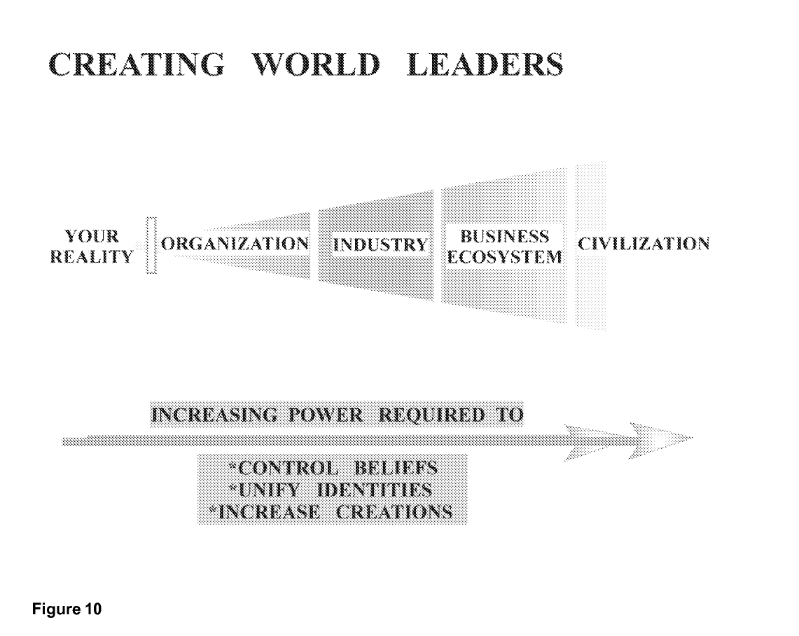

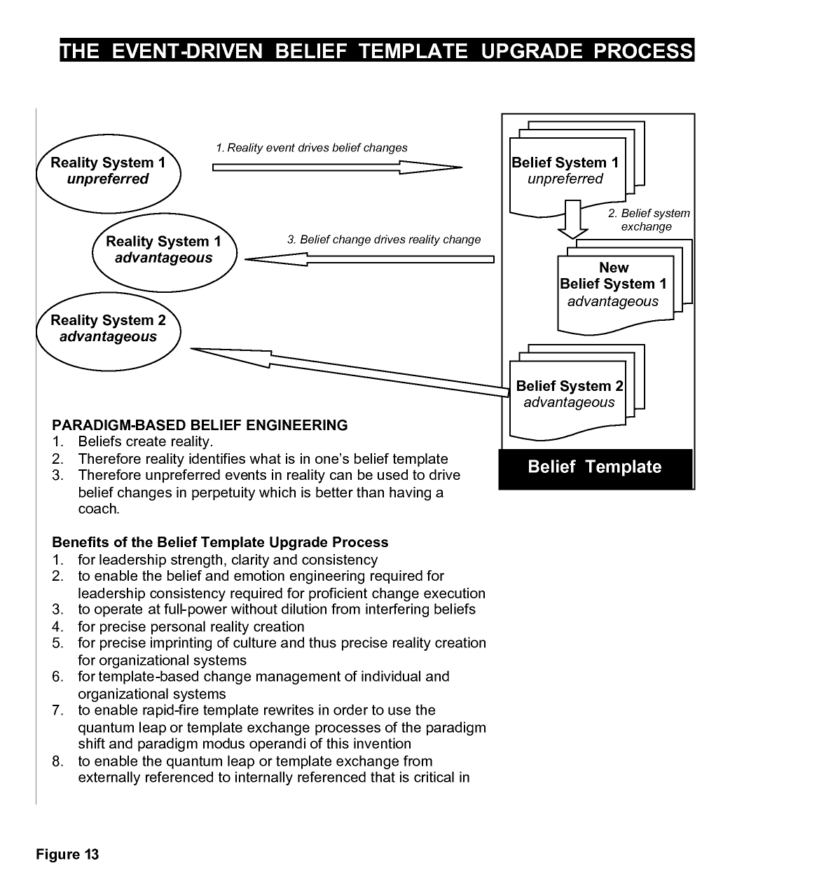

This presentation identifies new routes for leadership development available only in the paradigm of this invention:
(a) the amplification of the drives and dynamics built into the paradigm which advance the functionality and impact of the leader as illustrated in FIG. 9
(b) expansion by spheres around the core of a human system which defines the evolutionary path of said system, and thus the route to leadership development as illustrated by FIG. 10
(c) increased functionality based on the leader meta-competencies that emerge from the dynamics of the target paradigm
(d) expanding consciousness which emerges from compliance with the flow to congruence
(e) operating in talent-based flow which incites peak performance and evolution
(f) the evolution or advancement of the baseline potential of a system versus learning which is the addition of new information or growth which entails operating to one's full potential
(g) the paradigm-based quantum leap method and modus operandi inherent in the paradigm speeds leadership development and the advance of systems led and improves change management as illustrated by FIGS. 7 and 8
(h) the event-driven paradigm-based belief template upgrade method which constantly clarifies and consolidates the leader's belief system to advantage as demonstrated in FIG. 13.

FIG. 9 identifies a new continuum for leadership development based on the amplification of the leader drives and dynamics promoted by the paradigm of this invention. Said amplification causes managers who, by the redefinition in this invention, manage existing organizations and systems, to progress to transitional change leaders who linearly advance existing organizations, to transformational change leaders who change an existing business nonlinearly, to frontiering leaders and creational leaders who bring new systems into existence in the 2 aspects of dealing with the unknown which underpin the redefinition of leadership in the target paradigm: (a) the penetration of the unknown and (b) bringing the unknown into existence.

Leader empowerment and amplification is built into the paradigm so the invention continues to increase leader drives, reflexes and meta-competencies long after the formal program and action-learning experimentation process have been used. Conditioned reflexes in response to events in reality, as well as advantageous addictions and personalized strategies formulated for each person's natural drives and evolutionary continuum, all invoke a lifetime of leader amplification.

In the target paradigm, expansion by spheres around the natural core of a human system defines the evolutionary continuum of the system. The paradigm merges individuals with the flow to generative congruence internally and externally which is synergistically adapting, advancing and co-evolving systems. All of the dynamics of the target paradigm are linked to this continuous systems management process. Consequently, said flow will automatically advance and amplify leadership strength, impact and functionality for as long as participants remain within the paradigm founded on that flow. The expansion-by-spheres route to leadership development can be seen in FIG. 10 where the reality created and impacted by the leaders belief template expands from his/her own reality to that of an organization, an industry, a business ecosystem and then a civilization.

FIG. 10 also demonstrates the increased information available for decision-making as consciousness expands which is another of the routes to leadership development. More patterns in the life of an individual, a company, a marketplace, a country, or globally are evident to help the leader determine the logical natural themes of a system in the past and present so they can be projected out into the future in a way which capitalizes on them. This allows individuals to better identify company trends within market trends within the evolutionary trends of the human race, for example. This more expanded perspective can provide a logic convincing enough to incite even massive changes to product offerings, for example.

Personalizing the Paradigm

Presentation 8: Personalizing the Paradigm Through Five Personalized Formulas

Interactive instructor presentations or pre-recorded media presentations provide the information required to determine five formulas for each participant which will allow them to both personalize the paradigm and to capitalize to the maximum on the flow to congruence which activates the paradigm. Said five formulas based on the flow to congruence in each participant's life consist of: (a) a personal evolution formula (b) a personal leadership formula (c) a personal leadership development formula (d) a formula for one's greatest life-time performance goals as an individual (e) a formula for one's greatest life-time performance goals as a leader.

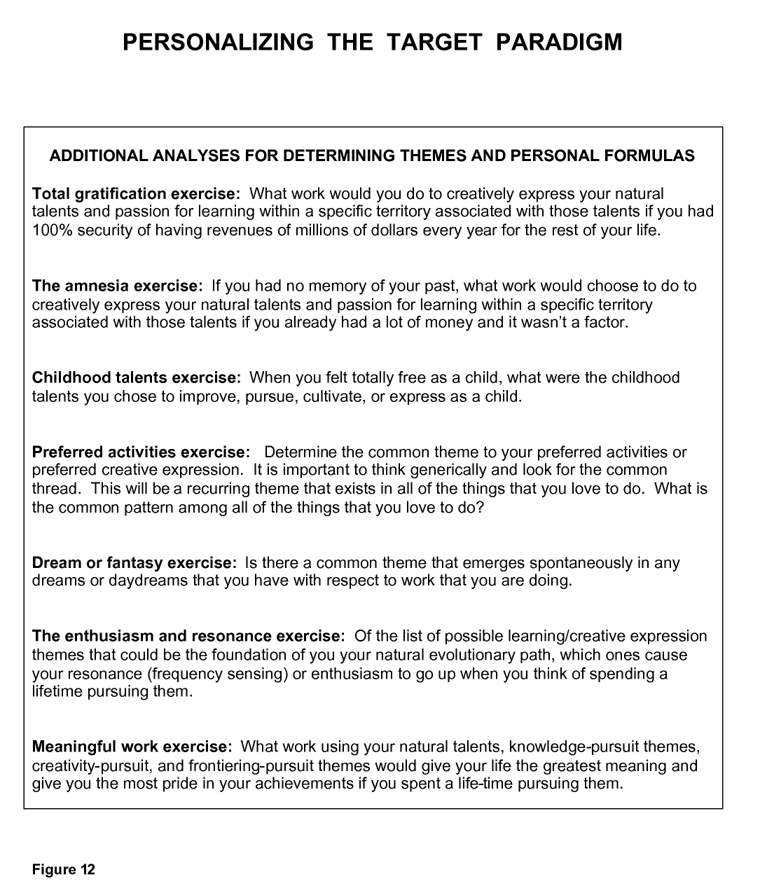

By analyzing the historical event patterns listed in FIG. 11, personal themes which comply with the flow to congruence in a participant's life can be developed through individual and group exercises. The identified themes can then be projected into the future to determine the five personal formulas that will maximize the participant. Said formulas are the best guess at the strategies that will allow the participant to capitalize on the flow to congruence and all of the accompanying dynamics in the paradigm to achieve peak performance and evolution. This peak achievement state is attained by operating in talent-based flow state within the talent-based flow-state of the contextual system. This flow-within-flow is the only logical foundation for achieving one's greatest performance as an individual and as a leader. The exercises of FIG. 12 offer additional information to contribute to the determination of the five personal formulas.

The historically-based knowledge-pursuit, creativity-pursuit, meaning-pursuit and frontiering-pursuit themes are particularly relevant for determining one's personal evolution formula. They also contribute to determining the formula for one's greatest life-time performance as an individual.

In the systems-based paradigm of the present invention, the evolution of any system is a nonlinear holographic expansion or intensification of the natural core of the system by quantum leaps rather than a gradual linear transition from point A to point B.

By taking the big-picture perspective of the redefinition of leadership and leadership development in the paradigm as described in Presentations 5 and 6 and customizing it for the personal evolution formula, the personal leadership formula becomes evident. An individual living their natural evolutionary formula in compliance with the flow to congruence internally and externally will be operating in talent-based flow state which is not only a peak performance state but an evolutionary state which automatically advances the baseline functionality of a system.

By overlaying the new paradigm-based leadership development process defined in presentation 7 onto the personal evolution formula and the personal leadership formula, a personal leadership development formula can be derived as well as the personal formula for one's greatest performance goals as a leader by extension. The result is a fully integrated customized foundation for greatness as a leader and an individual upon which classic leader competencies offered by traditional leadership development programs can be embedded.

Paradigm Personalization Analyses

Paradigm Personalization Analysis 1: Expert analysis by phone or in person for a preliminary hypothesis of the natural evolutionary formula, the leadership formula, and leadership development formula for each participant:

Brief details are summarized for each participant by an expert and compiled into a report to facilitate individual and group class exercises and the active learning support program. This report will be updated as the hypotheses for each of the five personal formulas are further refined and seem to be working in compliance with the flow to internal and external congruence.

Paradigm Personalization Analysis 2: 360s to establish a baseline performance from which to measure improvements based on the invention.

Paradigm Personalization Analysis 3: Myers-Briggs Type Indicator testing (MBTI) is done before the class because ratings will shift over time as natural growth and evolutionary mechanisms triggered by the invention actually change the baseline functionality of the individual. Shifts tend to augment and crystallize brain congruence represented by balanced and integrated left and right brain operation.

Paradigm Personalization Exercises

These exercises launch analyses that will be referenced within the formal program, the active-learning experimentation support programs, and for the rest of the participant's life. They may be initiated before any formal program is attended.

Paradigm Personalization Exercise 1: Inventory and analysis of lifetime or historical patterns of events for each participant:

This exercise begins the analysis of historical patterns of events which will persist throughout the entire program and lifetime of the participant. Said analysis will determine a participant's (a) creativity-pursuit theme, (b) knowledge-pursuit theme (c) frontier-pursuit theme, (d) personal evolutionary formula, (e) personal leader formula, (f) personal leadership development formula, (g) internal pressures to generative congruence, and (h) external pressures to generative congruence with co-evolving systems.

The historical patterns of the events that will be analyzed for themes are listed in FIG. 11: Event Patterns Tracked for Themes.

Paradigm Personalization Exercise 2: The launch of the process for determining each participant's personal evolutionary formula

From this analysis, a participant's personal leadership formula and leadership development formula will also be determined and formulas for his/her greatest performance as an individual and a leader. These exercises are designed to determine the flow to generative congruence internally and externally in the past in order to project them into the future so that participants might capitalize upon them. The below paradigm personalization exercises have been accumulated in FIG. 12 so that FIGS. 11, 12, and 13 enable a quick grasp of the paradigm personalization process of the present invention.

Paradigm Personalization Exercise 3: Meaningful work exercise: What work using your natural talents, knowledge-pursuit themes, creativity-pursuit, and frontiering-pursuit themes would give your life the greatest meaning and give you the most pride in your achievements if you spent a life time pursuing them.

Paradigm Personalization Exercise 4: Total gratification exercise: What work would you do to creatively express your natural talents and passion for learning within a specific territory associated with those talents if you had 100% security of having revenues of millions of dollars every year for the rest of your life.

Paradigm Personalization Exercise 5: The amnesia exercise: If you had no memory of your past, what work would choose to do to creatively express your natural talents and passion for learning within a specific territory associated with those talents if you already had a lot of money and it was not a factor.

Paradigm Personalization Exercise 6: Childhood talents exercise: When you felt totally free as a child, what were the childhood talents you chose to improve, pursue, cultivate, or express as a child.

Paradigm Personalization Exercise 7: Preferred activities exercise: Determine the common theme to your preferred activities or preferred creative expression. It is important to think generically and look for the common thread. This will be a recurring theme that exists in all of the things that you love to do. What is the common pattern among all of the things that you love to do?

Paradigm Personalization Exercise 8: Dream or fantasy exercise: Is there a common theme that emerges spontaneously in any dreams or daydreams that you have with respect to work that you are doing or want to be doing.

Paradigm Personalization Exercise 9: The Enthusiasm and Resonance Exercise: Of the list of possible learning-pursuit and creativity-pursuit themes that could be the foundation of your natural evolutionary path, which ones cause your resonance or frequency sensing capability or enthusiasm to go up when you think of spending a lifetime pursuing them.

Paradigm Personalization Exercise 10: Personal evolution formula and greatest achievement formula:

Each participant will develop a working hypothesis for his/her natural life-time development formula or personal evolution formula based on (a) paradigm personalization exercise 2 analyses, (b) paradigm personalization exercises 3 to 9, (c) invention presentations to this point, (d) presentation 8 in particular, and (e) the preliminary hypothesis for this natural development formula presented by the expert in the analysis 1. Each participant will then determine his/her greatest life-time level of talent-based performance based on the projected culmination of living his/her personal development formula.

Breakout Group 1 promotes sharing and group brainstorming to augment individual learning

Full-class quantum leap 7: to realigning your life to your naturality and the flow to generative congruence internally and externally as illustrated in FIGS. 10 and 11.

Full-class quantum leap 8: to a life founded on your knowledge-pursuit, creativity-pursuit, meaning-pursuit, and frontiering-pursuit themes so that you are (a) earning revenues doing only the work you are most passionately drawn to do, (b) using your talents to their maximum, and (c) being paid to learn the information and skills you would pursue anyway if you had total freedom.

Full-class quantum leap 9: to operating for the rest of your life in 100% talent-based flow state for peak performance and evolution.

Full-class quantum leap 10: to the next intensification or expansion or iteration of your life work or talent-based creative expression based on your knowledge-pursuit, creativity-pursuit, meaning-pursuit, and frontiering-pursuit themes, as one of many expansion quantum leaps that will become a way of life for the rest of your life.

A personal formulas list is begun which will contain the most up-to-date version of each participant's personal evolution formula, personal leadership formula, personal leadership development formula, and creativity-pursuit, frontier-pursuit, knowledge-pursuit and meaning-pursuit themes is provided to all participants (a) to enable the best input and advice and (b) to reinforce these personal formulas and themes within each participant so there is no backsliding.

Full-class quantum leap 11: to a person who has successfully operated for over 10 years at the level of your most profound life-time achievement based on working to your maximum on your knowledge-pursuit, creativity-pursuit, meaning-pursuit, and frontiering-pursuit themes. Leap to being a person who has operated 10 years at the highest levels of your talent-based creative expression or the highest creative expression of your talents. Leap to your ultimate state of peak performance and evolution with 100% internal and external congruence.

Paradigm Personalization Exercise 11: Personal Leadership formula:

Each participant will determine a working hypothesis for his/her personal leadership formula based on (a) these themes, (b) the presentations to this point of the present invention, and (c) the preliminary hypothesis for this formula presented by the expert in analysis 1.

Breakout Group 2 promotes sharing and group brainstorming to augment individual learning

Full-class quantum leap 12: to a leader who has been operating successfully by this personal leadership formula for the last 10 years using all of the advanced functionality and modus operandi of the paradigm of this invention.

Paradigm Personalization Exercise 12: Leadership development formula and greatest performance as a leader formula:

Each participant will determine a working hypothesis for his/her personal leadership development formula based on:
(a) the event patterns and themes,
(b) the presentations to this point of the present invention, and
(c) the preliminary hypothesis for his/her personal evolution formula and personal leadership formula presented by the expert in analysis 1. Each participant will then determine his/her greatest life-time level of performance as a leader based on the culmination of living his/her natural development formulas and the analyses of the previous paradigm personalization exercises.

Breakout Group 3 promotes sharing and group brainstorming to augment individual learning

Full-class quantum leap 13: to a leader who has spent the last 10 years in a state of accelerating evolution and now has all of the advanced functionality identified by this invention.

Full-class quantum leap 14: to a leader who has successfully operated for over 10 years at this level of your greatest life-time performance working to your maximum to capitalize on your knowledge-pursuit, creativity-pursuit, meaning-pursuit, and frontiering-pursuit themes.

Paradigm Personalization Exercise 13: Integration of the five personal formulas into work and life contexts.

Each participant will develop strategies for integrating their personal formulas and the target paradigm of this invention into his/her existing work context and life. Each participant will attempt to develop the practical application of the new learning into his/her job, company, career, and life.

Breakout Group 4 promotes sharing and group brainstorming to augment individual learning with respect to translating the new leader paradigm and learning into one's existing work, context, and life.

Action Learning Experimentation Exercise 1:

Participants will support each other by facilitated group telecalls and emails to achieve a practical integration into their existing work context and life of the target paradigm and their paradigm-based personal formulas for their greatest performance as an individual and a leader and their development of leadership strength in the paradigm of this invention.

Presentation 9: Belief Engineering

Interactive instructor presentations or pre-recorded media presentations launch the event-driven paradigm-based belief template upgrade method of the present invention for each participant to begin the process of managing his/her beliefs and the realities they create for the rest of their lives. Belief engineering is critical in a paradigm in which beliefs create reality and leadership is defined by bringing new realities into existence to be managed by managers. In the target paradigm of this invention, if nothing has changed in reality, leadership has not occurred. In the belief-created reality of this paradigm, for something in reality to change, beliefs have to have changed. Leaders need to be belief engineers to advance themselves and to lead change.

The purpose of event-driven paradigm-based belief template management is to create template congruence for
(a) operating at full-power without interfering beliefs,
(b) precision reality creation,
(c) consistency as a leader,
(d) for precision in imprinting culture,
(e) for the cultivation of cultures with distributed leadership, creativity, and frontiering,
(f) for template-based change management of individual and organizational systems including one's own personal and leadership development, and
(g) to enable rapid-fire template rewrites in order to use the quantum leap processes of the paradigm shift and paradigm modus operandi of this invention,
(h) to enable the belief and emotion engineering required for power and consistency in leaders;
(i) to enable the quantum leap from externally referenced to internally referenced that is critical in the creation and amplification of leaders;

Paradigm Personalization Exercise 14: Launch the Paradigm-Based Belief Template Upgrade Method

The purpose of this exercise is (a) to discover what beliefs are in your template (b) to houseclean your beliefs in order to develop a completely supportive belief template (c) to be able to change your belief template or system at will in order to change yourself and your reality advantageously in the shortest possible time.

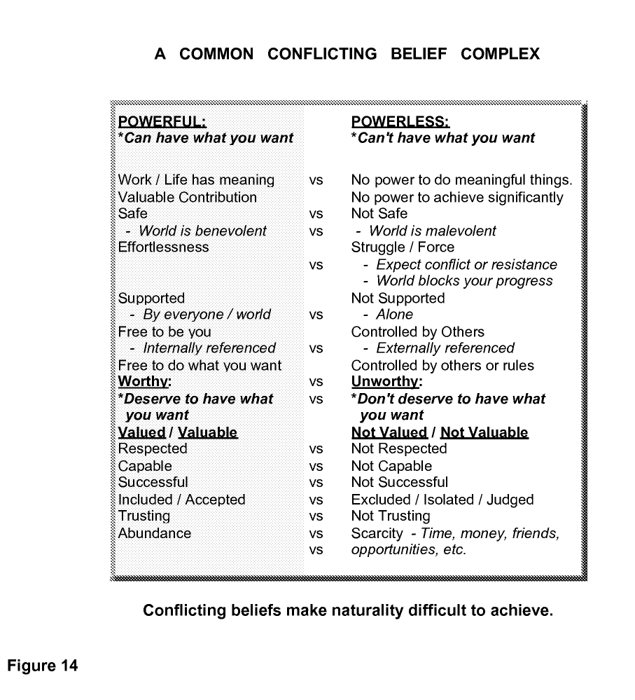

The exercise is comprised of these steps:
(a) assume reality is 100% belief-created in the paradigm of this invention; therefore, analysis of the patterns of events in reality will reveal the beliefs in one's template
(b) list the patterns of emotionally negative events or problem events, struggle events, fear events, and non-preferred events in the last three to six months
(c) determine one to three beliefs that must be in your belief template to have caused the worst of them; select from the right-hand column beliefs in FIG. 14 if they work for you; these are common interfering beliefs
(d) change the problem beliefs to those in the left-hand column of FIG. 14 to prevent further recurrence of those kinds of events.

Paradigm Personalization Exercise 15: Fear Belief Clearing Exercise

In a paradigm in which beliefs create reality, fear beliefs which are not cleared will create the reality feared.
(a) List the things you fear to identify your fear beliefs.
(b) Rate them out of 10 for how significant the fear is with 10 indicating the strongest fear.
(c) Visualize creatively solving those fears you rated as high.
(d) Repeat this exercise regularly to ensure the process is diffusing your fears.

Action Learning Experimentation Exercise 2: Belief Engineering exercises

Before and after the formal program, take opportunities to
(a) experiment to prove that beliefs create reality: patterns of recent events will indicate beliefs; categories of future events can be predicted from current beliefs; changing beliefs will change the events experienced;
(b) experiment with the paradigm-based quantum leap method used throughout the present invention;
(c) experiment with template-based leadership development and change leadership by quickly rewriting whole individual, organizational systems and cultural systems through quantum leaps;
(d) experiment with more precise reality creation;
(e) complete the quantum leap from externally referenced and created by one's reality to internally referenced and creating one's reality that is critical to leadership at full power.

Implementing Paradigm-Based Leadership

This section is designed to consolidate the paradigm shift of this invention by defining how (a) to operate within the paradigm, (b) to integrate it into one's work and life, and (c) to both develop as a leader and (d) to lead using the paradigm.

Presentation 10: Capitalizing on the Flow to Congruence for Leadership

With the determination of the five personal formulas for evolution, leadership, leadership development, and one's greatest life-time performance goals first as an individual and then as a leader, the invention has created the only foundation upon which to build leadership strength. Various leader meta-competencies based on the paradigm of this invention can now be embedded to complete the dynamic foundations of leadership and peak performance upon which traditional leadership development programs can add classic leader competencies.

Interactive instructor presentations or pre-recorded media presentations tell participants how the paradigm personalized by their five formulas can be used for effective leadership. The themes from FIG. 11 on which the five formulas are based tell participants where the flow of congruence is in their lives. Knowing where that flow is going and the accompanying dynamics identified in the paradigm offers a completely new modus operandi for leadership. This is what is explored in this presentation and the subsequent ones. Key paradigm dynamics are explored in leadership terms as: (a) quantum leap leadership (b) creation leadership (c) frontiering leadership (d) emergence leadership (e) flow leadership and the flow evolutionary continuum (f) evolution leadership (g) follower leadership (h) power leadership (i) unity leadership, and (j) world leadership.

The overarching object of this invention is to induce participants to absorb a critical mass of the paradigm of this invention to trigger a quantum leap to internalizing the whole paradigm. Said paradigm is logically interconnected and therefore one part can be deduced from another part. Then, rather than memorizing formulas to be followed, decision-making at each moment will be consistent with the paradigm and its leader drives, dynamics, and meta-competencies. The foundational energetics of natural leaders will have been internalized.

In addition, the paradigm offers a totally natural way to operate and therefore there are drives and mechanisms to sustain its modus operandi once incited. Each time one operates consistent with the paradigm, its addictive aspects, based primarily on the activation of these drives, will not only promote the continuation of this modus operandi but will continuously improve competency and power in operating this way. These drives are the ‘dynamics’ of our system—a mirror of the dynamics in the paradigm of this invention. All of the human systems operate in the paradigm generically the same. Therefore, change management for the development of the leader or systems led is the same.

Presentation 11: Quantum Leap Leadership

Interactive instructor presentations or pre-recorded media presentations translate the paradigm-based quantum leap method and the quantum leap modus operandi of the paradigm and the invention into practical ways to upgrade the application of the personalized leadership and leadership development formulas when participants are back at work and in life.

Quantum leaps allow a system to advance nonlinearly from one stable state to the next without the risky transitional states that often must exist when linear progress is insisted upon. Not only will quantum leaps be effective for advancing the leader's own system but also for advancing follower and organization systems led. Quantum leap leadership entails a template exchange process in the direction of the flow to congruence as the means to develop and advance systems led. Quantum leap leadership is a nonlinear change management process for rapidly advancing systems by wholes by using effective belief engineering and belief template management.

In order to keep pace with the perpetual flow to generative congruence internally and externally, leaders must master the art of belief engineering to architect the belief template exchanges and thus the exchange of the realities of systems. Even without template re-writes, there is a continuous pressure to quantum leap to new expansions or intensifications of the expression of the system as it exists.

To operate as a subset of nature's systems management process requires the continuous reintegration of systems into the flow to congruence. Either leaders have to get out of the way of this continuous quantum leap process that is automatically trying to maximize human systems or take manual control to capitalize on it by defining post-leaps, incorporating new information to fuel emergence, and embedding fluidity and a nonlinear modus operandi into the systems being led to incite them to continuously quantum leap as a way of life. All of this needs to be done within the organizational contexts where they work which may still be operating with primitive linear business processes and projects.

Breakout Group 5 promotes sharing and group brainstorming to augment individual learning and to generate creative solutions to the implementation challenges of participants preparing to integrate the paradigm dynamics of this invention into their work contexts.

Full-class quantum leap 15: to leading and advancing organizational systems and achieving organizational goals by quantum leaps which use paradigm-based dynamics, systems management, and template management.

Presentation 12: Frontiering Leadership: Penetrating the Unknown

Interactive instructor presentations or pre-recorded media presentations translate the frontiering aspects of the redefinition of leadership in the paradigm of this invention into practical terms for application in work contexts.

Managers manage what already exists. Leaders bring the new into existence whether that entails frontiering which pertains to penetrating the unknown or creation which pertains to creating the unknown. The person with the ability to safely, quickly and effectively penetrate unknown territory or bring the unknown into existence will be the leader. This invention cultivates the leader drives, dynamics, and meta-competencies which will not only making participants experts at frontiering but frontiering addicts in a good sense of the term. Frontiering is a continuous way of life in the paradigm of this invention since systems are perpetually advancing and adapting to each other and thus changing their shared context from known to unknown.

Penetrating unknown territory can also be viewed as a quantum leap from a known pre-leap reality to an unknown post-leap reality. Frontiering leadership, then, is, in essence, a quantum leap from a known reality to an unknown one. As such, it uses the paradigm-based quantum leap method of this invention.

The historical event patterns tracked in FIG. 11 and paradigm personalization exercises 1 and 2 were used to determine the flow to congruence internally and externally in each participant's life. If one is frontiering new territory or penetrating the unknown, it only makes sense to be proceeding in the same direction as the existing flow of systems to congruence. Therefore, by complying with these patterns each moment, said flow can keep one safe as one is proceeding into unknown territory because said flow is identifying the ideal direction for achieving congruence internally and externally for a system which is a perpetually re-centering state in a perpetually changing context. Leading organizational systems needs to be rethought with the concept of perpetual frontiering and the expertise for penetrating the unknown with the safety of the patterns as signposts (see the frontiering exercises below identified as Action Learning Experimentation Exercises 3 to 6). Leaders need to be comfortable living almost exclusively in frontiering-mode and this invention makes pioneering new territory a way of life.

Breakout Group 6 promotes sharing and group brainstorming to augment individual learning and to generate creative solutions to the implementation challenges for frontiering leadership by participants preparing to integrate the paradigm dynamics of this invention into their work contexts.

Full-class quantum leap 16: to frontiering leadership expert and addict which includes the leaps to an expert at the unknown, the ambiguous, the new; the identity of spontaneous knowledge expert; and the identity of coincidence creation expert;

Action Learning Experimentation Exercise 3: Post-Class analysis and action-learning exercises enable participants to detect, comply with, and capitalize on the co-evolutionary flow of subsystems based on patterns of events considered blocks to progress, flows to progress, coincidences speeding progress whereby coincidences are multi-system quantum leaps, and opportunistic synergy among co-evolving subsystems.

Action Learning Experimentation Exercise 4: Resonance Experiments: Experimentation with using the resonance-rating exercise as a means to penetrate the unknown safely and effectively for a selected goal which the participant does not know how to achieve.

Action Learning Experimentation Exercise 5: Checking the accuracy of the pattern of blocks and flows as demonstration of the safety of complying with the flow to congruence:
(a) Revisit some project you were trying to accomplish that ended up badly.
(b) Examine the events leading up to it.
(c) Were there lots of events blocking your progress?
(d) Take a look at other projects. Can you think of one which ended well?
(e) With 20/20 hindsight, can you see the pattern of signals from events in your reality which tried to warn you when you were going in the wrong direction and encourage you when you were going in the right direction?
(f) Were there signals early on in the pattern of blocks and flows of what you ultimately found to be the solution or the answer or the direction that made the project successful?

Action Learning Experimentation Exercise 6: The Cultivation of Coincidences to Catapult Progress:

A key tell-tale sign of alignment with the flow of systems to congruence is the emergence of clusters of coincidences. Coincidences are naturally occurring multi-system quantum leaps whereby co-evolving systems synergistically capitalize on each other to achieve adaptive or generative congruence. If a participant's system is complying with the flow to congruence, it will automatically be orchestrated into the right place and the right time for an opportunistic coincidence or natural quantum leap to occur. As a result, the more a participant complies with the flow to congruence, the more coincidences they experience, and the greater the speed, power and performance in achieving goals. One coincidence can save hundreds of steps that would normally be required to achieve a career goal, a work goal, or an organizational or market goal. Goals that one might think are impossible suddenly become possible through the cultivation of one or more coincidences. Creating and capitalizing on coincidences is a key focus of the paradigm-based redefined leadership of this invention.

A routine indicator of someone aligned with the flow to congruence is an increase in a special kind of coincidence: the emergence of spontaneous knowledge, especially as it pertains to an individual's knowledge-pursuit, creativity-pursuit, frontier-pursuit and meaning-pursuit goals. In addition, information coincidences also catapult individuals to goals and their next more advanced state even if they were not able to define that ideal next post-leap state. Both spontaneous knowledge and information coincidences increase markedly as one complies with the flow to congruence and are one way in which functionality and meta-competencies for penetrating the unknown increase with the present invention. Participants will devise experiments for both courting and capitalizing on coincidences in their work and life contexts.

Action Learning Experimentation Exercise 7: The Cultivation of Resonance for safety and direction in penetrating the unknown

Resonance is our frequency-sensing capability. The frequency goes up when we are taking action in the direction of the flow to internal and external congruence. It goes down when we are moving away from congruence. The patterns of events of high-frequency resonance are therefore consistent indicators of the flow to congruence. To begin to develop your resonance-sensing skill, start by making safe clerical-level requests for information and then, as your trust in yourself and your ‘staff’ increases, make larger and more risky decisions using resonance.

Choose experiments at each of the five levels of resonance expertise:
(a) initially, use resonance to penetrate the unknown for non-emotional things like clothes books, information, etc.
(b) then, apply resonance to non-emotional work related items that are particularly information-seeking.
(c) then move into higher risk situations where you are relying totally upon resonance because you cannot know the future or you do not have the information you need, since intellectually and knowledge-wise, you do not have the information to determine a direction.
(d) then begin applying resonance to emotionally-charged personal issues such as relationships, money, career, etc.
(e) finally, start reading even finer blocks, flows, and resonance patterns that emerge in response to thoughts or ideas in your mind as the events, suggesting the direction of your thinking rather than having to take actions out in the physical world to cause events for the reality computer to respond to with signal patterns indicating the flow to congruence.

Presentation 13: Creation Leadership: Creating the Unknown

Interactive instructor presentations or pre-recorded media presentations translate the creational aspects of the redefinition of leadership in the paradigm of this invention into practical terms for participants to apply in their work contexts.

Managers manage what already exists. Frontiering leaders lead the penetration of the unknown. Creational leaders lead the creation of the unknown. In a 100% belief-created reality, if nothing has changed in reality, leadership has not occurred. For something in reality to change, beliefs have to have changed. Creational leaders need to be belief engineers for both themselves and their organizations in order to lead the creation process. Creational leaders are reliant on the belief template exchange in FIG. 13. They replace a reality without a creation with a reality with a creation. Creational leaders therefore need to be as proficient as frontiering leaders at using the paradigm-based quantum leap modus operandi of this invention.

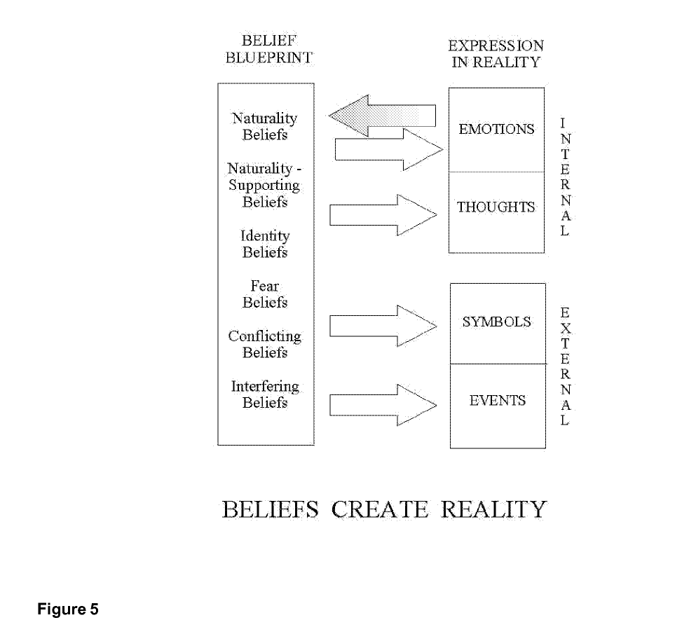

FIG. 5 demonstrates that reality is 100% created by beliefs whether the system is an individual, an organizational, or a cultural system. The belief template exchange of the paradigm-based quantum leap method of this invention illustrated in FIGS. 7 and 8 will therefore exchange the old reality for a new reality. Rather than managing a multitude of linear steps to achieve the desired goal, participants operating in the paradigm must now define and hold a post-leap emotional blueprint consistent with the flow of multiple systems to congruence and architect the belief and information changes required to fuel the emergence process to achieve the envisioned state. Spontaneous creation can be achieved through a quantum leap in reality.

The paradigm-based quantum leap method of this invention illustrated in FIGS. 7 and 8 must now be translated into the territory of leadership that brings new, often unknowable, realities into existence to solve, what can be defined in terms of the paradigm as system co-evolution and congruence challenges. Rather than leading individuals and organizations linearly forward, participants operating in the paradigm are leading a system and its reality combined as a single system by exchanging the single template of beliefs that creates both. Leadership by system belief template exchange is the quantum leap process of the invention and it allows nonlinear progress.

Nature uses creativity continuously to resolve the systems management challenges preventing generative congruence. Leaders can mirror this process or tap into it to re-optimize, adapt, advance, and synergistically co-evolve the organizational systems and market systems for which they are responsible. In the paradigm of this invention, creation projects needs to be chosen in the direction of the flow to congruence in order to harvest the forces and mechanisms that have evolved to maximize human systems.

Breakout Group 7 promotes sharing and group brainstorming to augment individual learning and to generate creative solutions to the implementation challenges for creational leadership by participants preparing to integrate the paradigm dynamics of this invention into their work contexts.

Full-class quantum leap 17: to both creation expert and creational leader with the belief engineering expertise, emotional engineering expertise, template management expertise, and quantum leap expertise required to achieve both.

Presentation 14: Emergence Leadership: Creating the New

Interactive instructor presentations or pre-recorded media presentations translate the emergence process in the paradigm of this invention into practical terms for application to leadership and peak performance in work contexts.

Emergence is a creative process that nature favors by which parts of existing systems are recombined to create a new information system—a whole that is greater than the sum of its parts. Emergence is not only the process used by a quantum leap in this invention as illustrated in FIGS. 7 and 8, it is itself a quantum leap: there is a template exchange between the old information structure and a new information structure.

Emergence is mechanism in the paradigm of this invention which nature uses to promote the flow to congruence of all human systems. Merging with the flow to congruence as proposed by this invention will therefore automatically trigger the process of emergence. Therefore said mechanism is available to leaders orchestrating individual and organizational systems into the flow to congruence for peak performance and evolution. This invention provides the strategy and structure for how leaders can orchestrate their troops and resources to imbed emergence into their corporate cultures to make even creativity-deficient organizations highly creative and problem-solving proficient.

The pieces of new information required to fuel emergence will emerge from the flow to congruence as information coincidences. Linear research for the requisite new information will only be required if the individual or the system drops out of the flow to congruence. When the collection of relevant existing information pieces is recombined, solutions that may never have existed before may result, or frontiers beyond what has been discovered to date may be penetrated. From emergence leadership, both leaders and organizations can end up developing their own “science”—technologies or disciplines or discoveries which have never existed before and by which they can lead industries and society.

Breakout Group 8 promotes sharing and group brainstorming to augment individual learning and to generate creative solutions to the implementation challenges for emergence leadership by participants preparing to integrate the paradigm dynamics of this invention into their work contexts.

Full-class quantum leap 18: to spontaneous knowledge and spontaneous creativity, creative inspiration, clusters of information coincidences, and penetrating the unknown.

Full-class quantum leap 19: to emergence expert who can source the new information pieces and set everything in motion so that emergence is triggered to bring new information and new realities into existence.

Action Learning Experimentation Exercise 8: Emergence information fuel

This exercise promotes experimenting with sourcing the new information required to catalyze the emergence process inherent in the paradigm and the paradigm-based quantum leap method of this invention. This exercise promotes experimenting to perfect expertise in sourcing the clusters of information coincidences requisite to fueling the emergence process. FIG. 7 demonstrates that there is no quantum leap if new information is not added to the pre-leap template to allow it to reformulate into the post-leap template.

(a) As a leader, orchestrate follower or organizational systems so they can collide with the information they need to fuel the emergence quantum leap.
(b) As a leader, revise organizational process and cultures so that linear project plans are not required before beginning projects nor rigidly enforced.

Presentation 15: Entrepreneur Leadership: Frontiering, Creation and Emergence

Interactive instructor presentations or pre-recorded media presentations provide the translation of the paradigm dynamics into the role of intrapreneur and entrepreneur leader: The paradigm-based redefinition of leadership in this invention specifies penetrating the unknown as in frontiering and bringing the unknown into existence as in creation and innovation. This means that everything promoted by this invention for leaders will also generate the ability to be an entrepreneur, intraprenuer, or an innovator. These are the key skills sought by every corporation in today's fast-changing world. They will become the norm as human beings evolve. The dynamics of the paradigm and the meta-competencies, drives, and reflexes that result from them, not only make companies successful, they define the future human. They define the ideal culture to be imprinted on highly competitive companies until they redefine the culture of society. The paradigm makes people addicts for creativity, innovation, frontiering new territory, learning, maximizing their talents in contexts of their choosing to achieve greatness.

Presentation 16: Flow Leadership and the Flow Evolutionary Continuum

Interactive instructor presentations or pre-recorded media presentations provide insights on how to lead systems to generative congruence internally and externally for peak performance, advanced functionality, and synergistic co-evolution with other systems sharing the same contextual system. Said flow to congruence internally and externally is illustrated in FIGS. 2 and 3 respectively. Flow state is the peak-performance, peak-evolution object state promoted by the paradigm of this invention for every participant and every system led. It is the ‘optimal experience’ according to Mihaly Csikszentmihalyi, author of “Flow” (1991) If that flow state is also in compliance with the flow to congruence of the contextual system, new levels of functionality and performance and evolution emerge. This ‘flow-within-flow’ is the only foundation upon which to build the greatest performance as an individual, a leader, and for systems led.

An individual in flow state is in congruence, a key object dynamic of the paradigm. A measurement of brain activity shows that only the parts of the brain required for the activity at hand are active. The brain is in congruence. With all parts of one's being trained on the activity at hand, peak performance results. To enter and sustain this state, one must be stretched beyond one's previous capabilities. Therefore, flow state is also a state of evolution since one's baseline functionality must advance every time one is in flow.

The speed with which one progresses along the flow evolutionary continuum to advanced functionality, such as expanded consciousness, spontaneous knowledge, and spontaneous creativity, is governed by the amount of time spent in a special form of flow called talent-based flow by this invention. This is a flow state based on the maximum usage of the natural talents which an individual or system has and is passionate about using. Said natural talents are the foundational activities associated with the individual's knowledge-pursuit themes, creativity-pursuit themes, frontiering-pursuit themes and meaning-pursuit themes determined during the paradigm personalization process by analyzing indicators of the flow to congruence.

The object of the invention then is to be in peak performance and evolution by being in talent-based flow state 100% of the time. Each participant will want to lead from talent-based flow state in a state of congruence internally and externally. They will also want to put follower systems, organizational systems, market systems, and customer systems in a state of congruence through talent-based flow. Leaders emerging from this invention will focus on getting all systems in internal and external flow to congruence or flow-within-flow to achieve the states of peak performance and evolution. Therefore, individuals will need to found their leadership on the personal leadership formula and personal leadership development formula derived from the present invention by determining a participant's flow-within-flow state of congruence.

Breakout Group 9 promotes sharing and group brainstorming to augment individual learning and to generate creative solutions to the implementation challenges for flow leadership by participants preparing to integrate the paradigm dynamics of this invention into their work contexts.

Full-class quantum leap 20: to
(a) an individual who achieves peak performance and evolution by living in talent-based flow state and flow-within-flow;
(b) a leader who leads in said flow state;
(c) a leader who orchestrates said flow state in followers and systems led;
(d) an individual speeding along the flow continuum who is transformed by every flow state to more expanded consciousness until unity consciousness is achieved and the breadth of perspective and conceptual skills resulting allow systems to be managed synergistically and opportunistically;
(e) spontaneous knowledge, spontaneous creativity, and the ability to stay permanently within congruence;

Presentation 17: Evolution Leadership

Interactive instructor presentations or pre-recorded media presentations translate the systems management process for the synergistic co-evolution of systems of this invention into practical terms for application in work contexts.

Evolution leadership is a specialized form of leadership development for those wanting to lead a territory of new knowledge or creation. Participants are individuals, teams, organizations, companies, industries, or disciplines seeking to advance a body of new knowledge or creation which will break through new frontiers.

For maximum results, participants should ideally be suited to or already advancing in the target frontier. This should be work that they have an inner knowing that they are meant to do. Indicators of suitability to look for in participant lives are talent-based flow states, meaning, passion, and patterns of blocks and flows, spontaneous creativity, spontaneous knowledge, coincidences, and a desire to learn associated with the theme targeting new knowledge or creation.

The reason to look for this match is because these individuals will be in talent-based flow-within-flow and can thus make maximum use of both their capabilities and the dynamics of the paradigm of this invention to advance at top speed and with the greatest impact. Evolution leadership can significantly evolve the human race or society.

Breakout Group 10 promotes sharing and group brainstorming to augment individual learning and to generate creative solutions to the implementation challenges for evolution leadership by participants preparing to integrate the paradigm dynamics of this invention into their work contexts.

Presentation 18: Follower Leadership

Interactive instructor presentations or pre-recorded media presentations translate the invention into practical application for
(a) the development of followers for peak performance and evolution
(b) the development of followers as leaders using the paradigm of this invention with its dynamics and paradigm-based quantum leap method
(c) leadership of followers as systems impacted by the flow to congruence
(d) leadership of followers as part of the systems management process of the paradigm of this invention which capitalizes on the flow of systems to congruence
(e) how to use action learning to shift followers into the paradigm of this invention while they are on the job,
(f) how to cultivate the leader drives, dynamics, and meta-competencies in followers and organizations led in order to establish a culture based on the paradigm of this invention.

Breakout Group 11 promotes sharing and group brainstorming to augment individual learning and to generate creative solutions to the implementation challenges for leading and developing followers as systems consistent with the paradigm of this invention.

Full-class quantum leap 21: to leading oneself and one's followers as a single system which one owns and directs. This is a more intensive version of quantum leap 6 which has been expanded to incorporate the personal formulas developed through this invention and the challenge of the practical implementation of follower leadership in the participant's work context.

Presentation 19: Power Leadership

Interactive instructor presentations or pre-recorded media presentations redefine power in the paradigm of this invention and translate it into practical application for leadership roles. This includes the territories of:
(a) personal power
(b) leader power
(c) organizational power
(d) the power to achieve, perform, influence and impact
(e) the power to bring new realities into existence—the very definition of leadership
(f) what one has the power to accomplish is amplified exponentially
(g) how one accomplishes is dramatically different, and
(h) the new dimensions of power that are available to those with the leader drives, dynamics, meta-competencies, consciousness, identities, and personal formulas of this invention.

The only basis for full power as a leader and an individual is to achieve internal congruence by centering the individual on his/her natural core while using his/her greatest talents in talent-based flow state while merged with the flow to congruence of the contextual system and advancing in the direction that the system and the contextual system are evolving. This is the formula for full power in the paradigm of this invention.

Breakout Group 12 promotes sharing and group brainstorming to augment individual learning and to generate creative solutions to the implementation challenges for power leadership within the paradigm of this invention.

Full-class quantum leap 22: to the redefined power of the paradigm of this invention and the ability to apply it within participant work contexts.

Presentation 20: Unity Leadership or Congruence Leadership

Interactive instructor presentations or pre-recorded media presentations describe how unity leadership will change how participants will lead followers and organizational systems:

Leaders unify. Individuals must have caused unification for leadership to have occurred. They must have taken individuals and organizations heading in different directions or with different perspectives and unified their direction, beliefs, emotions, and goals. They must have flowed human systems to congruence in the same way that nature does. Therefore, the two processes can be merged. Leadership can capitalize on and be enhanced by a natural process which is already ongoing.

In a paradigm which harnesses the flow to congruence and unity, there are a multitude of tools and techniques already built in to facilitate the unification work of leadership. The paradigm offers unique tools for replacing the fragmentation prevalent within organizations with cohesiveness and congruence which dwarfs the current state of team-building technologies to create a fully integrated value-creation engine.

One of said unique tools is the expanding consciousness dynamic of the paradigm. Consciousness will expand automatically as systems spend time complying with the flow to congruence internally and externally and operate in the talent-based flow state that is the object and result of congruence. As a result of said expanding consciousness, participants will have the broader perspective required to view and influence a wider span of interacting and co-evolving systems to opportunistically and synergistically take advantage of their co-evolution.

The unity consciousness which emerges as a result of this invention can add a whole new dimension to the unification role of leaders. Unity leadership can catalyze a pivotal unification process in any organization to a culture devoid of interfering fragmentation.

Breakout Group 13 promotes sharing and group brainstorming to augment individual learning and to generate creative solutions to the implementation challenges for the unification role of leaders based on the dynamics, drives and meta-competencies of the paradigm of this invention.

Full-class quantum leap 23: to a congruence leader who can integrate and co-evolve human systems

Presentation 21: World Leadership

Interactive instructor presentations or pre-recorded media presentations continue the material launched in Presentation 7: A New Paradigm-Based Leadership Development Process which explains how participants will expand to or intensify to world impact as a result of complying with the flow to congruence of this invention. This is illustrated by FIG. 10. Capacity for world impact will emerge based on
(a) the emergence of expanded consciousness
(b) the increased power and impact of belief-template clarity and fluidity
(c) increasing quantum leap and template management expertise
(d) increased power as one centers on the naturality and congruence of one's system
(e) identities or systems of beliefs with respect to leadership expanding in power and impact
(f) expansion in reality creation span of influence based on such things as
   (i) the quantum leap from externally referenced to internally referenced,
   (ii) belief engineering expertise,
   (iii) quantum leap expertise,
   (iv) frontiering and pathfinding expertise,
   (v) the quantum leap to being a single system with one's reality,
   (vi) unity consciousness,
   (vii) experiential learning and beliefs with respect to reality creation expertise and quantum leap expertise
(g) improved ability to comply with the patterns of events signaling the flow to congruence of co-evolving systems
(h) the release of all fragmentation and separation.

Full-class quantum leap 24: to the identity of world leader and the ability to impact the global system at will.

Presentation 22: Leader Consciousness Revisited

Interactive instructor presentations or pre-recorded media presentations recap all of the aspects of leader consciousness in the paradigm of this invention with a view to practical implementation. It gives participants an opportunity to know leadership in its most evolved form. The following aspects are included:
(a) leadership is a mirror and extension of nature's systems management process allowing leaders to capitalize on nature's superior creativity, knowledge, power, mechanisms, span of influence, and coincidences or multi-system quantum leaps
(b) a big-picture perspective and modus operandi for leadership that is systems-based and belief template-based
(c) capitalizing on the flow to congruence of any and all human systems by tracking the plurality of patterns of events which signal said flow internally and externally for each system
(d) change management based on belief template-exchanges or quantum leaps using nonlinear emergence rather than unstable linear transition states
(e) leaders are belief engineers
(f) leaders are emotional engineers
(g) leaders are reality architects
(h) leaders perpetually frontier new territory or penetrate the unknown
(i) leaders perpetually bring the new into existence or create the unknown
(j) talent-based flow is the peak performance and evolution state of any system and thus the ultimate goal of all leadership
(k) unity consciousness, non-dual consciousness, expanded consciousness, and systems thinking allow leaders to see the co-evolution of multiple systems inside and outside of the organization in order to determine the ideal direction in which to lead and to harness the synergy possible in an integrated process that is already occurring.

Full-class quantum leap 25: to the highest form of leadership bypassing all need for linear evolution.

Presentation 23: Life-Long Leader and Individual Amplification Process

Interactive instructor presentations or pre-recorded media presentations recap all of the mechanisms and aspects of leadership development, leader empowerment, and leader amplification introduced by this invention to give participants a consolidated view of the ultimate leader object state, the evolutionary process, and how the action-learning experimentation processes and methods of instruction that are part of the present invention will support the highest performance as a leader and an individual.

Action-Learning Experimentation Support

Presentation 24: Action-Learning Experimentation Support

The action-learning experimentation support sessions continue the work of the paradigm shift, the personalizing of the paradigm, the implementation of paradigm-based leadership, and the amplification process. They are based on the paradigm, dynamics, drives and meta-competencies, consciousness, identities, and paradigm-based quantum leap method of the present invention. Participants are supported in applying these to their work contexts and held accountable for goals that have been agreed to. The preferred embodiment is for said sessions to be held by teleconference. Action-learning experimentation support sessions for the preferred embodiment of the present invention consist of the following components:

The Paradigm of this Invention:

This paradigm is composed of the dynamics detailed in Presentations 1 to 4 of this invention and captured in the Figures. It is based on complying with and capitalizing on the flow of all human systems to generative congruence as indicated in FIGS. 2 and 3. The real leader of the support sessions is this congruence flow and the patterns of events in the past and present that indicate its direction that are identified in FIG. 11. Everything done in the action-learning experimentation support relates to complying with and capitalizing on said flow as illustrated in FIGS. 2 and 3 and the management of the belief template illustrated in FIGS. 5 and 13 for each system in order to do this. All advice from peers and leaders must be consistent with that force in each person's life and all of the components of the paradigm as identified in FIG. 1. Nothing is fragmented or separate from this fully integrated, logically interconnected paradigm. Sessions are therefore run from the paradigm's perspective of unity consciousness.

The Session Leaders:

Sessions are run by one leader or a team with the following strengths combined: knowledge of how to operate in the paradigm, leadership, project management, frontiering, strategic thinking, creative problem-solving, exceptional conceptual skills with, if possible, expanded consciousness. Session leaders will mobilize the group to hold participants accountable for their progress towards goals, offer creative directions for achieving those goals, and advise on operating within the paradigm of this invention.

A Session Theme:

Background information about the theme for each action-learning experimentation support session is presented prior to the session by pre-recorded media. Session themes are applications or reformulations of topics presented during the paradigm shift as included in this invention. They usually relate to operating within the paradigm to comply with or harness the flow to congruence and its practical application. Group quantum leaps lock in template changes each session.

Personal Formulas List:

A list of the most up-to-date version of each participant's personal development formula, leadership formula, leadership development formula, and creativity-pursuit, frontier-pursuit, knowledge-pursuit and meaning-pursuit themes is provided to all participants to empower the best input and advice and to reinforce these personal formulas within each participant so there is no regression. This information indicates the flow to congruence for each individual internally and externally and is the same list that was begun based on information collected in Paradigm Personalization Analysis 1.

Shared Experiential Learning:

Participants are invited to share paradigm-based experiences throughout the session but there is also a formal period of the session allotted to sharing what they have learned to speed the learning of others. This is not simply a general help line or basic coaching. Participants will learn directly or through others how the paradigm operates and how to capitalize on the flow to generative congruence as an individual and a leader.

Shared Paradigm-Based Group Goals:

The paradigm shift of the present invention launches a series of growth continuums for leader meta-competencies, drives, reflexes, consciousness, identities, and for internalizing the dynamics of the paradigm. The action-learning work and the support sessions for it integrate these growth continuums into the individual's current work life. Work and career goals are used as action-learning experimentation opportunities for achieving the advanced functionality and growth inherent in the paradigm of this invention.

The ultimate evolved states of the individual and the leader as defined in Presentations 22 and 23 are the overarching goals of the action-learning experimentation support program. If there are no changes to reality, leadership has not occurred. High-speed and high-impact generative changes to each participant's reality are therefore both the target and evaluator of the action-learning experimentation and the individual's performance.

Permanent upgrades to participant functionality and performance such as the following are sought: increasing leadership strength; faster leadership development; operating with leader reflexes, identities, drives, and meta-competencies; more effective assimilation of classic leader skills; capitalizing on the paradigm's dynamics; operating in peak-performance talent-based flow as the norm; flow-within-flow; accelerated evolution; and expanded consciousness. These are the precise long-term goals into which the challenges of the workplace are placed. This is different than most coaching programs which are driven by dysfunction of the individual and/or specific work challenges.

Participant Work/Career Goals:

These are the goals against which the paradigm can be tested and action learning achieved. Since integration into a single flow to generative congruence is sought, evolutionary, career, and business strategies are integrated and goals on any front will serve as action-learning experimentation opportunities.

Experimentation Feedback:

Experimenting to develop expertise for finding and capitalizing on the flow to generative congruence of co-evolving systems is another component of the action-learning experimentation support. Examples include: resonance-rating and resonance-testing exercises, pathfinding exercises, informationless decision-making exercises, leadership strength, pathfinding tests of blocks and flows and resonance, frontiering new territory, template management of multiple systems, orchestrating co-evolving systems, expanding consciousness, internally referenced and creating realities rather than externally referenced and created by reality, strengthening the leader identity. Some of the experimentation exercises have been identified above in Action-Learning Experimentation Exercises 1 to 8.

Group Quantum Leap(s):

Each session has one or more group quantum leaps based on the session theme and the content that emerges during the session. The quantum leap will lock in new beliefs, skill complexes, and modi operandi.

Through contributions by peers and facilitators, the following functions are also components of the action-learning experimentation support:
(a) a project management function to hold participants accountable for progress to shared and individual goals,
(b) a creative problem-solving function when the paradigm does not operate as expected or in an effort to achieve a more effective outcome for a participant,
(c) a creative strategizing function for maximizing the use of the paradigm for achieving personal and shared goals,
(d) a goal-setting function to ensure everyone will be pushing the envelope on his/her functionality and leadership strength between sessions.

The described embodiments are to be considered in all respects only as illustrative and not restrictive. Having shown and described the preferred embodiment of the invention, those skilled in the art or others will realize that many variations and modifications may be made to effect the described invention and still be within the scope of the claimed invention. Thus, many of the activities indicated herein may be altered or replaced by different activities which will provide the same result and fall within the spirit of the claimed invention. Modifications can be made without departing from the spirit and scope of the invention.

It is the intention, therefore, to limit the invention only as indicated by the scope of the appended claims. It is intended by the appended claims to cover all features and advantages of the invention which fall within the true spirit, essential characteristics, and scope of the invention. All changes which come within the meaning and range of equivalency of the claims are to be embraced within their scope. The invention should be construed broadly to include other variants and embodiments, which may be practiced within the scope and range of equivalents of the appended claims.

I claim:

1. A method for enhancing leadership, entrepreneurship, performance, innovation, creativity, and career achievement comprising the steps of:
presenting a plurality of interactive instructor or media presentations describing the target paradigm and paradigm shift method of this invention designed to install the meta-competencies, conditioned reflexes, drives, identity and consciousness of leaders, entrepreneurs, innovators and high achievers;
presenting an interactive instructor or media presentation describing a paradigm-based quantum leap method which exchanges the pre-leap belief template of a system for a post-leap one;

2. The method defined by claim 1 wherein said paradigm-based quantum leap method further comprises the steps of:
the pre-leap requires participants to
choose a paradigm-supported quantum leap or post-leap state which can capitalize on the flow to congruence,
define the post-leap state with clarity,
define the post-leap state without previous limitations or toxicity,
emotionally template the post-leap state,
add the information to fuel emergence,
expect the unexpected post-leap;
the leap requires participants to
release the linear connection to the past,
feel yourself 100% fluid,
feel the post-leap state,
feel what it is like to be the post-leap person
commit to the quantum leap,
make an abrupt, no-return, reincarnation,
trigger spontaneous self-organization by intent;
walk around as the person with the post-leap reality,
hold this new identity until reality restructures,
operate as if the quantum leap was successful;
the post-leap requires participants to
ignore evidence of events created by the old template,
trigger cascading quantum leaps by intent,
establish quantum leaping as a way of life,
consolidate the new quantum leap expert beliefs.

3. The method of claim 1 wherein said plurality of interactive instructor or media presentations further comprises:
a description of the target paradigm;
a description of a paradigm shift method comprising:
a paradigm-based quantum leap method,
a plurality of quantum leaps,
belief changes,
paradigm personalization exercises, and
a method of paradigm-based action-learning experimentation support;
a description of a paradigm-based quantum leap or belief template exchange method;
a paradigm-based method for redefining leadership and leadership development and the processes for leadership, leadership development, entrepreneurship, innovation, peak performance, and evolution;
a description of a paradigm-based leadership development method which merges with the human evolution continuum based on an intensification of the dynamics of the target paradigm;
instruction on how to personalize or customize the target paradigm;
instruction on paradigm-based belief engineering, a paradigm-based and event-driven belief template upgrade method, and template-based or systems-based leadership;
instruction on how to capitalize on the dynamics of the target paradigm especially the dynamics of congruence, quantum leaping, frontiering, creativity, emergence, flow, and evolution;
instruction on how to operate, lead, achieve, evolve, and amplify within the target paradigm;
instruction on implementing the paradigm-redefined leadership comprising:
quantum leap leadership,
frontier leadership pertaining to penetrating the unknown,
creation leadership pertaining to creating the unknown,
emergence leadership pertaining to creating the new,
entrepreneur leadership pertaining to frontiering, creation and emergence,
flow leadership and the flow evolutionary continuum,
evolution leadership,
follower leadership,
power leadership,
unity leadership or congruence leadership,
world leadership, and
leader consciousness;
instruction on a life-long paradigm-based amplification process;
instruction on how to integrate the target paradigm into one's existing work context and life.

4. The method of claim 1 wherein the target paradigm of this invention further comprises:
a systems management perspective of synergistically and opportunistically adapting, advancing, and co-evolving human systems which metaphorically mirrors what nature's perspective would be whether said systems are individual follower systems, organizational systems, customer systems, market systems, or processes such as organizational change systems or career management systems;
using said systems management perspective identically for leading, leadership development, personal development, peak performance, innovation, and evolution;
said dynamics which underpin the object meta-competencies, drives, and reflexes of natural leaders, entrepreneurs, high achievers, and innovators comprising:
a congruence dynamic,
a systems-based dynamic,
a systems adaptation dynamic,
a co-evolution dynamic,
an evolution dynamic,
a spontaneous self-organizing dynamic,
an emergence dynamic,
a templating dynamic,
a quantum leap dynamic,
a creation/creativity dynamic,
a frontiering dynamic,
a knowledge-pursuit dynamic,
a flow dynamic,
a flow-within-flow dynamic whereby both the subsystem and its contextual system are in the flow to congruence,
an expanding consciousness dynamic;
said congruence dynamic which is the flow of human systems to generative congruence internally and externally resulting in the plurality of other said dynamics shared by every human system and underpinning said object meta-competencies, drives and reflexes of leaders, entrepreneurs, innovators, and high achievers;
said flow of human systems to generative congruence individually and collectively which is one of the most important of said dynamics governing the paradigm since the power of the present invention derives from complying with and capitalizing on said flow;
logical integration of the target paradigm whereby every part can be deduced from any other part because, first, said nature's perspective being copied is already integrated and, second, integration is built into said flow of systems to generative congruence;
a plurality of drives that links human systems to said flow to generative congruence which are automatically amplified as a byproduct of operating in said target paradigm to levels shared by leaders, entrepreneurs and innovators, said plurality of drives includes:
frontiering, change, achievement,
creativity, creation, innovation,
adaptation, learning, growth,
resonance, congruence, self-expression,
our peak-performance and peak-growth ‘flow state’ which is a state of consciousness that expresses physical, mental and emotional congruence, and
a drive to the ultimate congruence, that of expanded or unity consciousness;
said meta-competencies resulting from said dynamics and said drives which enhance leadership, entrepreneurship, innovators, and peak performance include those relating to
learning and learning agility, knowing, creating,
frontiering, cognitive capabilities, accelerated growth,
evolution, peak performance, talent-based flow,
systems thinking, system-based emotional intelligence,
expanding consciousness, expanding self-expression,
expanding self-awareness and internal reference,
continuous adaptation and re-optimization,
co-evolution with contextual systems, fluidity,
achievement and advancement by nonlinear quantum leaps,
informationless decision-making, and accelerated implementation;
said flow to generative congruence internally and externally which is identified from historical patterns of events in the life of each individual or organizational human system;
said historical patterns of events which are organized into personalized themes which the human system can capitalize upon in the present and future; said personalized themes comprising:
a knowledge-pursuit theme based on patterns of events of seeking knowledge passionately and willingly for the application of key talents,
a frontier-pursuit theme based on patterns of events of new territories of growth, learning and achievement the system was drawn to pursue for the application of key talents,
a creativity-pursuit theme based on patterns of events of preferred creative expression or creative expression which the participant or system was drawn to pursue for the application of key talents plus events in which creativity or creative invention or innovation spontaneously or coincidentally emerged for the application of key talents,
a meaning-pursuit theme based on patterns of events of work or achievements or contributions considered a meaningful application of key talents,
the theme(s) of talent-based flow states indicated by patterns of events whereby the participant went into flow state during the application of key talents,
a resonance theme based on patterns of subjects or activities for the application of key talents with which the participant experienced a high-frequency resonating reaction,
a positive emotion theme based on patterns of events in which passion, excitement, and enthusiasm emerged during the application of key talents,
a spontaneous knowledge theme which is based on patterns of work-like events in which spontaneous knowledge emerged to support the application of key talents,
theme(s) of projects requiring the application of key talents which were supported by lots of coincidences and flow events indicating they were integrated into the flow to congruence as is the case with each of the above themes;
a talent-based flow state which generates the internal congruence that is the object state of being within said target paradigm which emerges as a byproduct of participants applying their key natural talents on tasks that are in compliance with their knowledge-pursuit, frontier-pursuit, creativity-pursuit, and meaning-pursuit themes which signal the flow to congruence;
a flow-within-flow state which is the state of external congruence whereby an individual human system is in said talent-based flow state while merged with the talent-based flow state of the contextual system of which the system is a part thus achieving the object state of said flow to generative congruence internally and externally;
said object state of being within the paradigm which is not just a state of learning which adds new information to one's existing system, nor growth which is defined as operating to the full potential of one's existing system, but evolution whereby the potential of a system is functionally increased so the system operates beyond its previous potential through a partnership with the power and mechanisms of said flow to generative congruence;
a direction of evolution in the paradigm whereby human systems advance nonlinearly by an intensification or expansion by quantum leaps around the natural core of the system thus making said direction of evolution an expansion by spheres around the defining information structure of a system composed of its genes and belief template;
said belief template which defines each human system and its reality simultaneously thus unifying them into a single system manageable by said template;
a 100% self-created and belief-created which allows
the beliefs in said template of a system to be known by the events in its reality;
the reality experienced by a system to be changed by changing its beliefs,
the beliefs that need to be upgraded in said belief template to be identified by the less preferred events they create in the system's reality creating an event-driven paradigm-based belief template upgrade method that contributes to the flow to generative congruence internally and externally in said target paradigm, and
reality to become a self-correcting feedback system;
said quantum leap dynamic which is the means for systems to advance, adapt, and co-evolve nonlinearly by wholes from one stable state to the next rather than having to be kept safe and viable through states of linear transition;
a paradigm-based quantum leap method whereby quantum leaps must advance in the direction of said flow to generative congruence in order to capitalize on its power, mechanisms, and information to fuel said quantum leaps;
said paradigm-based quantum leap method whereby a quantum leap, the pre-leap belief template is exchanged with the post-leap belief template to advance the system and its reality as a single system.

5. The method of claim 4 wherein an event-driven paradigm-based belief template upgrade method, further comprises:
a plurality of interactive instructor or media presentations comprising:
describing why a paradigm-based method of belief template exchange is pivotal to
the method for the paradigm shift in the present invention,
the paradigm-based quantum leap method of the present invention,
the plurality of quantum leaps of which said paradigm shift is composed, and
the paradigm-based method of change management for all systems led,
describing that belief template congruence and thus system congruence are pursued in the target paradigm in order
for precise reality creation in a target paradigm in which beliefs create reality,
to operate at full-power without interfering beliefs and thus interfering realities,
to enable the belief and emotion engineering required for
the power and consistency required for leadership,
precise imprinting of culture which is a system or template of beliefs,
cultivating cultures with distributed leadership, creativity, and frontiering, and
template-based change management of individual and organizational systems including one's own personal development and leadership development,
to enable rapid-fire template rewrites in order to use the paradigm-based quantum leap method of the paradigm shift and the paradigm modus operandi of this invention, and
to enable the quantum leap from externally referenced to internally referenced that is critical in the creation and amplification of leaders in a target paradigm in which beliefs create reality;
describing that in the target paradigm of this invention, each human system and its reality are integrated as a single system based on a single belief template;
describing that the reality of each system in the paradigm is 100% self-created and belief-created;
describing that the beliefs in the template of a human system can be known by the events in its reality;
describing that the reality experienced by a system can be changed by changing its beliefs;
describing that the beliefs that need to be upgraded in the belief template can be identified by the less preferred events they create in the system's reality making belief changes event-driven and incited by reality;
describing that this is the foundation of said event-driven paradigm-based belief template upgrade method that is part of the flow to internal and external generative congruence in the target paradigm;
describing that reality thus functions as a self-correcting feedback system pressuring the flow to generative congruence internally and externally;
a plurality of exercises comprising:
having each participant list the patterns of emotionally negative events or problem events, struggle events, fear events, and non-preferred events in the last 3-6 months;
having each participant determine which 1 to 5 problem beliefs must be in his/her belief template to cause said negative events;
instructing participants to change said negative beliefs to prevent further recurrence of the less-preferred events they create in order to achieve a completely supportive belief template for the next reality s/he wants to experience;
experimenting with template-related paradigm-based action-learning exercises
to prove that beliefs create reality,
to prove that future realities and events can be predicted based on existing beliefs,
to develop expertise in changing beliefs to change the events experienced,
to develop expertise with the paradigm-based quantum leap method used throughout the present invention which are based on belief-template changes,
to develop expertise with template-based leadership development and change leadership in order to quickly rewrite whole individual systems, organizational systems and cultural systems by quantum leaps or template exchanges,
to develop expertise for more precise reality creation, and
to gather the beliefs from experiential learning that are necessary to complete the quantum leap from externally referenced and created by one's reality to internally referenced and creating one's reality that is critical to leadership at full power in the target paradigm.

6. The method of claim 1 wherein said paradigm shift method further comprises the steps of:
using a plurality of interactive instructor or media presentations to:
overview and provide detailed instructions for a paradigm-based quantum leap method, clearly define the target paradigm which serves as the generic post-leap or post-shift state,
provide information for motivating said paradigm shift,
provide the necessary belief systems for the exchange of the pre-shift belief template for the post-shift belief template, and
provide information as fuel for the emergence process which will catalyze the recombination of information systems to create the new information of said post-shift belief template as required for a quantum leap transformation;
breaking the paradigm shift into a plurality of quantum leaps each of which will feed a small portion of target paradigm or post-shift information and belief changes to participants in smaller systems for easier assimilation;
personalizing said target paradigm or post-shift state by a paradigm personalization exercise whereby said flow to generative congruence internally and externally for each participant's system is determined by analyzing historical patterns of life events indicative of said object flow to congruence to identify personalized themes;
improving the clarity of said target paradigm or post-shift state through said paradigm personalization exercise whereby each participant uses said personalized themes to develop five paradigm-based personal formulas comprising:
a personal evolution formula,
a personal leadership formula,
a personal leadership development formula,
a greatest life-time performance formula as an individual, and
a greatest life-time performance formula as a leader;
further improving the clarity of the target paradigm or post-shift state through said paradigm personalization exercise by defining how participants will operate with various key dynamics of said target paradigm such as frontiering, flow, creativity, and emergence, once the paradigm shift is complete;
further improving the clarity of the target paradigm or post-shift state through said paradigm personalization exercise by having participants plan for the integration of the target paradigm into their life and work contexts;
providing a point of commitment to the paradigm shift or quantum leap whereby the pre-shift state ceases to exist and is replaced by the defined post-shift state;
having each participant make an abrupt, no-return, reincarnation into the post-shift state;
having participants operate as if the paradigm shift or quantum leap has been successful;
having participants walk around as the person with the post-shift reality;
having participants ignore contrary evidence provided by events created by the pre-shift belief template;
having participants hold this new system of beliefs as an identity until the belief-created reality restructures as a reflection of the new post-shift beliefs.

7. The method of claim 6 wherein said plurality of quantum leaps for internalizing the target paradigm to achieve the paradigm shift, personalizing the paradigm, and leading and operating in the paradigm, said plurality further comprises the following quantum leaps:
to a life realigned to said flow to generative congruence internally and externally and the continuous expansion of one's natural core and talent-based creative expression;
to a life founded on one's personalized life themes especially one's knowledge-pursuit, creativity-pursuit, meaning-pursuit, and frontier-pursuit themes so that one is earning revenues doing only the work one is most passionately drawn to do, using one's talents to their maximum, and being paid to learn the information and skills one would pursue anyway if one had total freedom;
to operating for the rest of one's life in 100% talent-based flow state for peak performance and evolution;
to the next intensification or expansion or frontier of one's life work or talent-based creative expression based on one's knowledge-pursuit, creativity-pursuit, meaning-pursuit, and frontier-pursuit themes, and the launch of a life time of such expansion quantum leaps;
to a person who has successfully operated for over 10 years at the highest levels of one's talent-based creative expression based on applying oneself to one's knowledge-pursuit, creativity-pursuit, meaning-pursuit, and frontier-pursuit themes;
to one's ultimate peak performance and evolution state with 100% internal and external congruence;
to a leader who has been operating successfully with his/her personal leadership formula for the last 10 years with all of the advanced functionality and modus operandi of the target paradigm of this invention;
to a leader who has successfully operated for over 10 years at this level of his/her greatest life-time performance as a result of working at peak performance in compliance with one's knowledge-pursuit, creativity-pursuit, meaning-pursuit, and frontier-pursuit themes;
to a quantum-leap leadership expert who leads and advances organizational systems and achieves organizational goals by quantum leaps, wholes, systems, and nature's multi-system quantum leaps to congruence known as coincidences;
to a frontiering leadership expert and addict which includes the leaps to
being an expert in the ambiguous, the new, and penetrating the unknown,
being an expert in spontaneous knowledge,
being an expert in spontaneous creativity;
being an expert in creating and harnessing coincidences, and
being an expert in capitalizing on the flow to congruence;
to creation expert, creational leader, and the belief engineering expert required to achieve both;
to an emergence expert who can source the new information systems and set everything in motion so that emergence is triggered to recombine new and old systems and beliefs to bring new information and new realities into existence;
to a flow leader who leads in flow state and who orchestrates flow state in followers and systems led; to an individual who achieves peak performance and evolution by living in flow state and flow-within-flow, whereby said flow-within-flow occurs when both the subsystem and its contextual system are in the flow to congruence;
to leading oneself and one's followers as a single system which one owns and directs;
to an expert in the redefined power of the target paradigm of this invention and the ability to apply it within participant work contexts;
to a congruence leader who can integrate and co-evolve human systems;
to the identity of world leader and the ability to impact the global system at will;
to the highest form of leadership defined in the target paradigm whereby all need for linear evolution is eliminated.

8. The method of claim 1, further comprising the steps of:
completing a quantum leap to internalize said quantum leap expertise to become a quantum leap expert;
completing a quantum leap to internalize the target paradigm;
providing a paradigm-based redefinition of leadership and leadership development and the processes for leadership, entrepreneurship, leadership development, peak performance, innovation, and evolution based on the paradigm of this invention;
completing a plurality of quantum leaps comprising the following quantum leaps:
to leader consciousness,
to the expanding identity of leader,
from externally referenced to internally referenced,
to an expanded identity which includes both oneself and everything in one's belief-created reality;

9. The method of claim 8 wherein said paradigm-based redefinition of leadership and leadership development and the processes for leadership, leadership development, entrepreneurship, innovation, peak performance, and evolution, further comprise:
a redefinition of leadership as operating the target paradigm of the present invention, whereby said redefinition comprises:
using nature's systems management process as a metaphor for systems-based leadership;
redefining the generic work of leaders as the synergistic and opportunistic adaptation, advancement, and co-evolution of human systems whether said systems are individual follower systems, organizational systems, customer systems, market systems, or processes which form systems such as leadership development, organizational change, or career management; and
redefining said generic work of leaders as capitalizing on natural forces which have evolved to adapt, advance, and co-evolve human systems to increase generative congruence;
a redefinition of leadership as having the same system of dynamics as the target paradigm of the present invention, whereby said redefinition comprises:
said dynamics of the target paradigm which underpin the object meta-competencies, drives, and reflexes of leaders, entrepreneurs, peak performance, peak evolution, and peak impact, whereby said dynamics include:
Individual System Organization dynamics:
a spontaneous self-organizing dynamic, a systems-based dynamic, a congruence dynamic, a templating dynamic, an emergence dynamic,
Multi-System Organization dynamics:
a systems adaptation dynamic, a co-evolution dynamic, an expanding consciousness dynamic, a flow-within-flow dynamic whereby both the subsystem and its contextual system are merged in the flow to congruence,
Improved Performance and Functionality dynamics: a quantum leap dynamic, a creation/creativity dynamic, a frontiering dynamic, a flow dynamic, a peak evolution dynamic, a knowledge-pursuit dynamic,
redefining leadership in terms of key paradigm dynamics to explain quantum leap leadership, frontier leadership pertaining to penetrating the unknown, creation leadership pertaining to creating the unknown, emergence leadership pertaining to creating the new, entrepreneur leadership, unification leadership, congruence leadership, flow leadership, world leadership, evolution leadership, and follower leadership,
redefining said generic work of leaders in terms of said congruence dynamic whereby the advancement of all individual and organizational human systems is universally based on leading them into said flow to generative congruence internally and externally,
redefining said generic work of leaders in terms of said frontiering dynamic whereby the unknown is penetrated plus said creation/creativity dynamic whereby the unknown is brought into existence,
redefining said generic work of leaders as leading in the unknown as either a creative act or a frontiering act to make the unknown known, and
redefining said generic work of the leader as taking place in the leader zone which is the unknown between existing reality and the next reality;
a redefinition of the generic work of managers as managing said existing realities or systems or what is known;
a redefinition of the manager-leader partnership whereby leaders generate new systems and realities and managers run them;
a redefinition of leadership development as a series of paradigm-based leadership development continuums indicating directions of progress comprising:
a continuum based on an amplification of said dynamics inherent in the target paradigm which advances the functionality and impact of the leader and advances participants from managers who, by the redefinition in this invention, manage existing organizations, to progress to transitional change leaders who linearly advance existing organizations, to transformational change leaders, who advance an existing business nonlinearly, to frontiering leaders and/or creational leaders who penetrate the unknown and bring the unknown into existence,
a continuum based on said amplification of said dynamics which will strengthen leader drives and meta-competencies to allow participant to advance through the better assimilation and use of the classic leader competencies and skills offered by traditional leadership development programs,
a continuum based on an expansion by spheres around the natural core of an individual or organizational human system which
defines a development continuum which is simultaneously the evolutionary path of said system and the leadership development continuum, and
in a paradigm in which beliefs create reality, indicates how the expanding core of the leader can impact expanding realities, advancing from the leader's reality to an organization's reality, to an industry's reality, to a business ecosystem, to a civilization's reality, to a planetary reality,
a continuum based on the evolution inherent in said flow to generative congruence in the target paradigm which is already adapting, advancing and co-evolving systems in perpetuity including the leader's own system and thus making life-long leadership development automatic in the target paradigm,
a continuum based on said flow to generative congruence which promotes a state of congruence called flow state which is an addicting state of peak performance, accelerating evolution, increasing functionality, and expanding consciousness thus developing individuals and leaders automatically in perpetuity,
a continuum based on belief engineering to improve the congruence of the belief template of the leader which includes:
the event-driven paradigm-based belief template upgrade method which constantly clarifies and consolidates the leaders belief systems to advantage, and
the paradigm shift method which enables the participants to assimilate a series of belief systems until all paradigm-based beliefs have been assimilated and emergence and synergies have launched a life-long belief improvement method,
a continuum based on the paradigm-based quantum leap method which becomes profoundly transformative for the leader and systems led when experiential learning and relevant beliefs increase the participant's proficiency with quantum leaps,
a continuum based on the installation of conditioned reflexes by the invention which are triggered by internal and external events which cause cumulative progress and increases in impact and functionality over time and eventually result in leadership become instinctive, automatic and addictive,
a continuum based on the addictive quality of the leader drives and said dynamics promoted by the target paradigm whereby each use and improvement in proficiency reinforces the addiction thus building leadership development into said target paradigm,
a continuum based on expanding consciousness which automatically emerges over time as a result of compliance with said flow to generative congruence, and said expanding consciousness
is a meta-competency which informs all other leadership skills to upgrade leader performance on every front,
provides more information on possible synergies among co-evolving systems thus improving strategic planning, conceptual thinking, informationless decision making, and dealing with the unknown, and
provides unity consciousness from which leaders can better perform the requisite role of unifier to unify systems.

10. The method of claim 1, further comprising the steps of:
personalizing the paradigm and the paradigm shift by completing a paradigm personalization exercise for each participant to develop five paradigm-based formulas comprising his/her personal evolution formula, personal leadership formula, personal leadership development formula, greatest life-time performance formula as an individual, and greatest life-time performance formula as a leader;

11. The method of claim 10 wherein said paradigm personalization exercise further comprises the steps of:
analyzing the historical patterns of ‘work’ events in the following categories for themes, said events and themes comprising:
a knowledge-pursuit theme based on patterns of events of seeking knowledge passionately and willingly for the application of key talents,
a frontier-pursuit theme based on patterns of events of new territories of growth, learning and achievement the system was drawn to pursue for the application of key talents,
a creativity-pursuit theme based on patterns of events of preferred creative expression or creative expression which the participant or system was drawn to pursue for the application of key talents plus events in which creativity or creative invention or innovation spontaneously emerged for the application of key talents,
a meaning-pursuit theme based on patterns of events of work or achievements or contributions considered a meaningful application of key talents,
the theme(s) of talent-based flow states indicated by patterns of events whereby the participant went into flow state during the application of key talents,
a resonance theme based on patterns of subjects or activities for the application of key talents with which the participant resonated whereby their resonance or frequency-sensing or enthusiasm intensified
a positive emotion theme based on patterns of events in which passion, excitement, and enthusiasm emerged during the application of key talents,
a spontaneous knowledge theme based on patterns of work-like events in which spontaneous knowledge emerged to support the application of key talents,
theme(s) of projects requiring the application of key talents which were supported by lots of coincidences and flow events indicating they were integrated into the flow to congruence as is the case with each of the above themes,
a total gratification exercise whereby participants are asked what work they would do to creatively express their natural talents and passion for learning within a specific territory associated with those talents if they had 100% security with respect to having revenues of millions of dollars every year for the rest of your life,
an amnesia exercise whereby participants are asked to imagine if they had no memory of their past, what work they would choose to do to creatively express their natural talents and passion for learning within a specific territory associated with those talents if they already had a lot of money and it was not a factor,
a childhood talents exercise whereby participants are asked to think back to when they felt totally free as a child and identify what were the childhood talents they chose to improve, pursue, cultivate, or express,
a preferred activities exercise whereby participants are asked to identify generically, what the common theme or pattern to their preferred activities or preferred creative expression is,
a dream or fantasy exercise whereby participants are asked to determine the common theme that emerges in any dreams or daydreams that they have with respect to work they would like to be doing,
an enthusiasm and resonance exercise whereby participants are asked to list possible learning-pursuit and creation-pursuit themes that could be the foundation of their natural evolutionary path and determine which ones cause their resonance or frequency-sensing or enthusiasm to go up when they think of spending a lifetime pursuing them,
a meaningful work exercise whereby participants are asked to identify what work using their natural talents, knowledge-pursuit themes, creation-pursuit, and frontiering-pursuit themes would give their life the greatest meaning and give them the most pride in their achievements if they spent a life time pursuing them;
analyzing themes from the above patterns indicating the flow to internal and external congruence are analyzed to determine the best working hypotheses for each participant's personal evolution formula, personal leadership formula, personal leadership development formula, greatest life-time performance formula as an individual, and greatest life-time performance formula as a leader;
developing a practical implementation strategy for integrating each participant's personalized paradigm and personal formulas into his/her existing life, work and career context and personal, leader and career development;
updating the group personal formula database and list with the most recent said hypotheses for each participant's five formulas as well as his/her themes for creativity-pursuit, frontier-pursuit, knowledge-pursuit and meaning-pursuit to improve peer advice and to encourage the intensification of each participant while preventing backsliding; and
supporting fellow participants through facilitated peer group telecalls and emails to achieve a practical integration of each participant's personalized paradigm into his/her existing life, work and career context and personal, leader, and career development.

12. The method of claim 1, further comprising the steps of:
completing a further plurality of quantum leaps comprising the following quantum leaps:
to a life realigned to the flow to generative congruence internally and externally and the continuous expansion of one's natural core and talent-based creative expression,
to a life founded on one's knowledge-pursuit, creativity-pursuit, meaning-pursuit, and frontier-pursuit themes so that one is earning revenues doing only the work one is most passionately drawn to do, using one's talents to their maximum, and being paid to learn the information and skills one would pursue anyway if one had total freedom,
to operating for the rest of one's life in 100% talent-based flow state for peak performance and evolution,
to the next intensification or expansion or frontier of one's life work or talent-based creative expression based on one's knowledge-pursuit, creativity-pursuit, meaning-pursuit, and frontier-pursuit themes, and the launch of a life time of such expansion quantum leaps,
to one who has successfully operated for over 10 years at the highest levels of one's talent-based creative expression based on applying oneself to one's knowledge-pursuit, creativity-pursuit, meaning-pursuit, and frontier-pursuit themes,
to one's ultimate peak performance and peak evolving state merged with and capitalizing on the flow to generative congruence internally and externally,
to a leader who has been operating successfully with his/her personal leadership formula for the last 10 years with all of the advanced functionality and modus operandi of the paradigm of this invention, and
to a leader who has successfully operated for over 10 years at this level of his/her greatest life-time performance as a result of working at peak performance in compliance with one's knowledge-pursuit, creativity-pursuit, meaning-pursuit, and frontier-pursuit themes;
describing in a plurality of presentations how to operate, lead, and entrepreneur in the target paradigm from the perspective of key dynamics of the paradigm, said dynamics comprising:
a spontaneous self-organizing dynamic,
a systems-based dynamic,
a congruence dynamic,
a templating dynamic,
an emergence dynamic,
a systems adaptation dynamic,
a co-evolution dynamic,
an expanding consciousness dynamic,
a flow-within-flow dynamic whereby both subsystem and the contextual system of which it is a part are in the flow to congruence,
a quantum leap dynamic,
a creation/creativity dynamic,
a frontiering dynamic,
a flow dynamic,
an evolution dynamic,
a knowledge-pursuit dynamic,
a frontiering dynamic,
completing a plurality of quantum leaps comprising the following quantum leaps:
to leading oneself and one's followers as a single system which one owns and directs,
to frontiering leadership expert and addict which includes the leaps
to an expert in the ambiguous, the new, and penetrating the unknown,
an expert in spontaneous knowledge,
an expert in spontaneous creativity,
an expert in creating and harnessing coincidences, and
an expert in capitalizing on the flow to congruence,
to the identity of coincidence creation expert,
to a creation expert and creational leader and the belief engineering expert required to achieve both,
to an emergence leader and expert who can source the new information pieces and set everything in motion so that emergence is triggered to recombine new and old information systems and beliefs to bring new information and new realities into existence,
to a flow leader who leads in flow state and who orchestrates flow state in followers and systems led which includes being an individual who achieves peak performance and evolution by living in flow state and flow-within-flow whereby both a subsystem and its contextual system are in flow state as both flow to congruence,
to a congruence leader who can integrate and co-evolve human systems;
describing a life-long leader amplification process;
describing in a plurality of presentations how to amplify and intensify one's strength and impact in said target paradigm through flow leadership and the flow evolutionary continuum, through evolution leadership, through power leadership, through unity leadership, through world leadership, through expanding leader consciousness, and through a life-long leader amplification process;
completing a plurality of group quantum leaps comprising the following quantum leaps:
to the redefined power of said target paradigm of this invention and the ability to apply it within participant work contexts,
to the identity of world leader and the ability to impact the global system at will, and
to the highest form of leadership bypassing all need for linear evolution;
initiating a continuation of said paradigm personalization exercise whereby each participant develops a plan for integrating his/her new learning, his/her five personal formulas, and the paradigm of this invention into his/her existing work context, career, and life; and
initiating a method of paradigm-based action-learning experimentation support to help participants integrate said target paradigm and new learning into his/her job, company, career, and life and achieve all of the functionality, meta-competencies, drives, reflexes, peak performance, evolution and highest life-time achievements possible through this invention.

13. The method of claim 12 wherein said method of paradigm-based action-learning experimentation support, further comprises:
regular facilitated group meetings or calls with peer participants to accelerate leadership, personal, and career development based on the invention;
each peer group action-learning experimentation support session is comprised of
the target paradigm of this invention,
session leaders,
a paradigm-based session theme,
a paradigm-based personal formulas list for all participants,
shared paradigm-based experiential learning,
shared paradigm-based group goals,
participant work/career goals to be used for action-learning experimentation,
paradigm-based experimentation feedback,
the paradigm-based quantum leap method of this invention,
at least one relevant group paradigm-based quantum leap per call, and
through contributions by peers and facilitators, the following functions are components of the action-learning experimentation support program provided by group process:
a project management function,
a creative problem-solving function, and
a goal-setting function.

14. A target paradigm of this invention comprising:
a systems management perspective of synergistically and opportunistically adapting, advancing, and co-evolving human systems which metaphorically mirrors what nature's perspective would be whether said systems are individual follower systems, organizational systems, customer systems, market systems, or processes such as organizational change systems or career management systems;
using said systems management perspective identically for leading, leadership development, personal development, peak performance, innovation, and evolution;
said dynamics which underpin the object meta-competencies, drives, and reflexes of leaders, entrepreneurs, high achievers, and innovators, comprising:
a congruence dynamic, a systems-based dynamic,
a systems adaptation dynamic, a co-evolution dynamic,
an evolution dynamic, a spontaneous self-organizing dynamic,
an emergence dynamic, a templating dynamic,
a quantum leap dynamic, a creation/creativity dynamic,
a frontiering dynamic, a knowledge-pursuit dynamic,
a flow dynamic,
a flow-within-flow dynamic whereby both the subsystem and its contextual system are in the flow to congruence,
an expanding consciousness dynamic;
said congruence dynamic which is the flow of human systems to generative congruence internally and externally resulting in the plurality of other said dynamics shared by every human system and underpinning said object meta-competencies, drives and reflexes of leaders, entrepreneurs, innovators, and high achievers;
said flow of human systems to generative congruence individually and collectively which is one of the most important of said dynamics governing the paradigm since the power of the present invention derives from complying with and capitalizing on said flow;
logical integration of the target paradigm whereby every part can be deduced from any other part because, first, said nature's perspective being copied is already integrated and, second, integration is built into said flow of systems to generative congruence;
a plurality of drives that links human systems to said flow to generative congruence which are automatically amplified as a byproduct of operating in said target paradigm to levels shared by leaders, entrepreneurs and innovators, said plurality of drives includes:
frontiering, change, achievement,
creativity, creation, innovation,
adaptation, learning, growth,
resonance, congruence, self-expression,
our peak-performance and peak-growth ‘flow state’ which is a state of consciousness that expresses physical, mental and emotional congruence, and
a drive to the ultimate congruence, that of expanded or nondual or unity consciousness;
said meta-competencies resulting from said dynamics and said drives which enhance leadership, entrepreneurship, innovators, and peak performance include those relating to
learning and learning agility, knowing, creating,
frontiering, cognitive capabilities, accelerated growth,
evolution, peak performance, talent-based flow,
systems thinking, system-based emotional intelligence,
expanding consciousness, expanding self-expression,
expanding self-awareness and internal reference,
continuous adaptation and re-optimization,
co-evolution with contextual systems, fluidity,
achievement and advancement by nonlinear quantum leaps,
informationless decision-making, and accelerated implementation;
said flow to generative congruence internally and externally which is identified from historical patterns of events in the life of each individual or organizational human system;
said historical patterns of events which are organized into personalized themes which the human system can capitalize upon in the present and future; said personalized themes comprising:
a knowledge-pursuit theme based on patterns of events of seeking knowledge passionately and willingly for the application of key talents,
a frontier-pursuit theme based on patterns of events of new territories of growth, learning and achievement the system was drawn to pursue for the application of key talents,
a creativity-pursuit theme based on patterns of events of preferred creative expression or creative expression which the participant or system was drawn to pursue for the application of key talents plus events in which creativity or creative invention or innovation spontaneously or coincidentally emerged for the application of key talents,
a meaning-pursuit theme based on patterns of events of work or achievements or contributions considered a meaningful application of key talents,
the theme(s) of talent-based flow states indicated by patterns of events whereby the participant went into flow state during the application of key talents,
a resonance theme based on patterns of subjects or activities for the application of key talents with which the participant experienced a high-frequency resonating reaction,
a positive emotion theme based on patterns of events in which passion, excitement, and enthusiasm emerged during the application of key talents,
a spontaneous knowledge theme which is based on patterns of work-like events in which spontaneous knowledge emerged to support the application of key talents,
theme(s) of projects requiring the application of key talents which were supported by lots of coincidences and flow events indicating they were integrated into the flow to congruence as is the case with each of the above themes;
a talent-based flow state which generates the internal congruence that is the object state of being within said target paradigm which emerges as a byproduct of participants applying their key natural talents on tasks that are in compliance with their knowledge-pursuit, frontier-pursuit, creativity-pursuit, and meaning-pursuit themes which signal the flow to congruence;
a flow-within-flow state which is the state of external congruence whereby an individual human system is in said talent-based flow state while merged with the talent-based flow state of the contextual system of which the system is a part thus achieving the object state of said flow to generative congruence internally and externally;
said object state of being within the paradigm which is not just a state of learning which adds new information to one's existing system, nor growth which is defined as operating to the full potential of one's existing system, but evolution whereby the potential of a system is functionally increased so the system operates beyond its previous potential through a partnership with the power and mechanisms of said flow to generative congruence;
a direction of evolution in the paradigm whereby human systems advance nonlinearly by an intensification or expansion by quantum leaps around the natural core of the system thus making said direction of evolution an expansion by spheres around the defining information structure of a system composed of its genes and belief template;
said belief template which defines each human system and its reality simultaneously thus unifying them into a single system manageable by said template;
a 100% self-created and belief-created which allows:
the beliefs in said template of a system to be known by the events in its reality;
the reality experienced by a system to be changed by changing its beliefs,
the beliefs that need to be upgraded in said belief template to be identified by the less preferred events they create in the system's reality creating an event-driven paradigm-based method of belief template upgrade that is part of the flow to generative congruence internally and externally in said target paradigm, and
reality to become a self-correcting feedback system;
said quantum leap dynamic which is the means for systems to advance, adapt, and co-evolve nonlinearly by wholes from one stable state to the next rather than having to be kept safe and viable through states of linear transition;
a paradigm-based quantum leap method whereby quantum leaps must advance in the direction of said flow to generative congruence in order to capitalize on its power, mechanisms, and information to fuel said quantum leaps; and
said paradigm-based quantum leap method whereby a quantum leap, the pre-leap belief template is exchanged with the post-leap belief template to advance the system and its reality as a single system.

15. An event-driven paradigm-based belief template upgrade method, comprising:
a plurality of interactive instructor or media presentations comprising:
describing why an event-driven paradigm-based belief template upgrade method is pivotal to
the method for the paradigm shift in the present invention,
the paradigm-based quantum leap method of the present invention,
the plurality of quantum leaps of which said paradigm shift is composed, and
the paradigm-based method of change management for all systems led,
describing that belief template congruence and thus system congruence are pursued in the target paradigm in order
for precise reality creation in a target paradigm in which beliefs create reality,
to operate at full-power without interfering beliefs and thus interfering realities,
to enable the belief and emotion engineering required for
the power and consistency required for leadership,
precise imprinting of culture which is a system or template of beliefs,
cultivating cultures with distributed leadership, creativity, and frontiering, and
template-based change management of individual and organizational systems including one's own personal development and leadership development,
to enable rapid-fire template rewrites in order to use the paradigm-based quantum leap method of the paradigm shift and the paradigm modus operandi of this invention, and
to enable the quantum leap from externally referenced to internally referenced that is critical in the creation and amplification of leaders in a target paradigm in which beliefs create reality;
describing that in the target paradigm of this invention, each human system and its reality are integrated as a single system based on a single belief template;
describing that the reality of each system in the paradigm is 100% self-created and belief-created;
describing that the beliefs in the template of a human system can be known by the events in its reality;
describing that the reality experienced by a system can be changed by changing its beliefs;
describing that the beliefs that need to be upgraded in the belief template can be identified by the less preferred events they create in the system's reality making belief changes event-driven and incited by reality;
describing that this is the foundation of said event-driven paradigm-based belief template upgrade method that is part of the flow to internal and external generative congruence in the target paradigm;
describing that reality thus functions as a self-correcting feedback system pressuring the flow to generative congruence internally and externally;
a plurality of exercises comprising:
having each participant list the patterns of emotionally negative events or problem events, struggle events, fear events, and non-preferred events in the last 3-6 months;
having each participant determine which 1 to 5 problem beliefs must be in his/her belief template to cause said negative events;
instructing participants to change said negative beliefs to prevent further recurrence of the less-preferred events they create in order to achieve a completely supportive belief template for the next reality s/he wants to experience;
experimenting with template-related paradigm-based action-learning exercises
to prove that beliefs create reality,
to prove that future realities and events can be predicted based on existing beliefs,
to develop expertise in changing beliefs to change the events experienced,
to develop expertise with the paradigm-based quantum leap method used throughout the present invention which are based on belief-template changes,
to develop expertise with template-based leadership development and change leadership in order to quickly rewrite whole individual systems, organizational systems and cultural systems by quantum leaps or template exchanges,
to develop expertise for more precise reality creation, and
to gather the beliefs from experiential learning that are necessary to complete the quantum leap from externally referenced and created by one's reality to internally referenced and creating one's reality that is critical to leadership at full power in the target paradigm.

16. A paradigm-based redefinition of leadership and leadership development and the processes for leadership, leadership development, entrepreneurship, innovation, peak performance, and evolution comprise:
a redefinition of leadership as operating the target paradigm of the present invention, whereby said redefinition comprises:
using nature's systems management process as a metaphor for systems-based leadership;
redefining the generic work of leaders as the synergistic and opportunistic adaptation, advancement, and co-evolution of human systems whether said systems are individual follower systems, organizational systems, customer systems, market systems, or processes which form systems such as leadership development, organizational change, or career management; and
redefining said generic work of leaders as capitalizing on natural forces which have evolved to adapt, advance, and co-evolve human systems to increase generative congruence;
a redefinition of leadership as having the same system of dynamics as the target paradigm of the present invention, whereby said redefinition comprises:
said dynamics of the target paradigm which underpin the object meta-competencies, drives, and reflexes of leaders, entrepreneurs, peak performance, peak evolution, and peak impact, whereby said dynamics include:
Individual System Organization dynamics:
a spontaneous self-organizing dynamic, a systems-based dynamic, a congruence dynamic, a templating dynamic, an emergence dynamic,
Multi-System Organization dynamics:
a systems adaptation dynamic, a co-evolution dynamic, an expanding consciousness dynamic, a flow-within-flow dynamic whereby both the subsystem and its contextual system are merged in the flow to congruence,
Improved Performance and Functionality dynamics: a quantum leap dynamic, a creation/creativity dynamic, a frontiering dynamic, a flow dynamic, a peak evolution dynamic, a knowledge-pursuit dynamic,
redefining leadership in terms of key paradigm dynamics to explain quantum leap leadership, frontier leadership pertaining to penetrating the unknown, creation leadership pertaining to creating the unknown, emergence leadership pertaining to creating the new, entrepreneur leadership, unification leadership, congruence leadership, flow leadership, world leadership, evolution leadership, and follower leadership,
redefining said generic work of leaders in terms of said congruence dynamic whereby the advancement of all individual and organizational human systems is universally based on leading them into said flow to generative congruence internally and externally,
redefining said generic work of leaders in terms of said frontiering dynamic whereby the unknown is penetrated plus said creation/creativity dynamic whereby the unknown is brought into existence,
redefining said generic work of leaders as leading in the unknown as either a creative act or a frontiering act to make the unknown known, and
redefining said generic work of the leader as taking place in the leader zone which is the unknown between existing reality and the next reality;
a redefinition of the generic work of managers as managing said existing realities or systems or what is known;
a redefinition of the manager-leader partnership whereby leaders generate new systems and realities and managers run them;
a redefinition of leadership development as a series of paradigm-based leadership development continuums indicating directions of progress comprising:
a continuum based on an amplification of said dynamics inherent in the target paradigm which advances the functionality and impact of the leader and advances participants from managers who, by the redefinition in this invention, manage existing organizations, to progress to transitional change leaders who linearly advance existing organizations, to transformational change leaders, who advance an existing business nonlinearly, to frontiering leaders and/or creational leaders who penetrate the unknown and bring the unknown into existence,
a continuum based on said amplification of said dynamics which will strengthen leader drives and meta-competencies to allow participant to advance through the better assimilation and use of the classic leader competencies and skills offered by traditional leadership development programs,
a continuum based on an expansion by spheres around the natural core of an individual or organizational human system which:
defines a development continuum which is simultaneously the evolutionary path of said system and the leadership development continuum, and
in a paradigm in which beliefs create reality, indicates how the expanding core of the leader can impact expanding realities, advancing from the leader's reality to an organization's reality, to an industry's reality, to a business ecosystem, to a civilization's reality, to a planetary reality,
a continuum based on the evolution inherent in said flow to generative congruence in the target paradigm which is already adapting, advancing and co-evolving systems in perpetuity including the leader's own system and thus making life-long leadership development automatic in the target paradigm,
a continuum based on said flow to generative congruence which promotes a state of congruence called flow state which is an addicting state of peak performance, accelerating evolution, increasing functionality, and expanding consciousness thus developing individuals and leaders automatically in perpetuity,
a continuum based on belief engineering to improve the congruence of the belief template of the leader which includes:
the event-driven paradigm-based belief template upgrade method which constantly clarifies and consolidates the leaders belief systems to advantage, and
the paradigm shift method which enables the participants to assimilate a series of belief systems until all paradigm-based beliefs have been assimilated and emergence and synergies have launched a life-long belief improvement method,
a continuum based on the paradigm-based quantum leap method which becomes profoundly transformative for the leader and systems led when experiential learning and relevant beliefs increase the participant's proficiency with quantum leaps,
a continuum based on the installation of conditioned reflexes by the invention which are triggered by internal and external events which cause cumulative progress and increases in impact and functionality over time and eventually result in leadership become instinctive, automatic and addictive,
a continuum based on the addictive quality of the leader drives and said dynamics promoted by the target paradigm whereby each use and improvement in proficiency reinforces the addiction thus building leadership development into said target paradigm, and
a continuum based on expanding consciousness which automatically emerges over time as a result of compliance with said flow to generative congruence, and said expanding consciousness:
is a meta-competency which informs all other leadership skills to upgrade leader performance on every front,
provides more information on possible synergies among co-evolving systems thus improving strategic planning, conceptual thinking, informationless decision making, and dealing with the unknown, and
provides unity consciousness from which leaders can better perform the requisite role of unifier to unify systems.

17. A paradigm personalization exercise comprising the steps of:
analyzing the historical patterns of ‘work’ events in the following categories for themes, said events and themes comprising:
a knowledge-pursuit theme based on patterns of events of seeking knowledge passionately and willingly for the application of key talents,
a frontier-pursuit theme based on patterns of events of new territories of growth, learning and achievement the system was drawn to pursue for the application of key talents,
a creativity-pursuit theme based on patterns of events of preferred creative expression or creative expression which the participant or system was drawn to pursue for the application of key talents plus events in which creativity or creative invention or innovation spontaneously emerged for the application of key talents,
a meaning-pursuit theme based on patterns of events of work or achievements or contributions considered a meaningful application of key talents,
the theme(s) of talent-based flow states indicated by patterns of events whereby the participant went into flow state during the application of key talents,
a resonance theme based on patterns of subjects or activities for the application of key talents with which the participant resonated whereby their resonance or frequency-sensing or enthusiasm intensified,
a positive emotion theme based on patterns of events in which passion, excitement, and enthusiasm emerged during the application of key talents,
a spontaneous knowledge theme based on patterns of work-like events in which spontaneous knowledge emerged to support the application of key talents,
theme(s) of projects requiring the application of key talents which were supported by lots of coincidences and flow events indicating they were integrated into the flow to congruence as is the case with each of the above themes,
a total gratification exercise whereby participants are asked what work they would do to creatively express their natural talents and passion for learning within a specific territory associated with those talents if they had 100% security with respect to having revenues of millions of dollars every year for the rest of their lives,
an amnesia exercise whereby participants are asked to imagine if they had no memory of their past, what work they would choose to do to creatively express their natural talents and passion for learning within a specific territory associated with those talents if they already had a lot of money and it was not a factor,
a childhood talents exercise whereby participants are asked to think back to when they felt totally free as a child and identify what were the childhood talents they chose to improve, pursue, cultivate, or express,
a preferred activities exercise whereby participants are asked to identify generically, what the common theme or pattern to their preferred activities or preferred creative expression is,
a dream or fantasy exercise whereby participants are asked to determine the common theme that emerges in any dreams or daydreams that they have with respect to work they would like to be doing,
an enthusiasm and resonance exercise whereby participants are asked to list possible learning-pursuit and creation-pursuit themes that could be the foundation of their natural evolutionary path and determine which ones cause their resonance or frequency-sensing or enthusiasm to go up when they think of spending a lifetime pursuing them,
a meaningful work exercise whereby participants are asked to identify what work using their natural talents, knowledge-pursuit themes, creation-pursuit, and frontiering-pursuit themes would give their life the greatest meaning and give them the most pride in their achievements if they spent a life time pursuing them;
analyzing themes from the above patterns indicating the flow to internal and external congruence are analyzed to determine the best working hypotheses for each participant's personal evolution formula, personal leadership formula, personal leadership development formula, greatest life-time performance formula as an individual, and greatest life-time performance formula as a leader;
developing a practical implementation strategy for integrating each participant's personalized paradigm and personal formulas into his/her existing life, work and career context and personal, leader and career development;
updating the group personal formula database and list with the most recent said hypotheses for each participant's five formulas as well as his/her themes for creativity-pursuit, frontier-pursuit, knowledge-pursuit and meaning-pursuit to improve peer advice and to encourage the intensification of each participant while preventing backsliding;
supporting fellow participants through facilitated peer group telecalls and emails to achieve a practical integration of each participant's personalized paradigm into his/her existing life, work and career context and personal, leader, and career development.
